(19) United States
(12) Patent Application Publication
(10) Pub. No.: US 2022/0140398 A1
(43) Pub. Date: May 5, 2022

(54) Electrolytes for Low Temperature Applications

(71) Applicant: Nanyang Technological University, Singapore (SG)

(72) Inventors: Wei ZHANG, SINGAPORE (SG); Xiaodong CHEN, SINGAPORE (SG)

(21) Appl. No.: 17/519,960

(22) Filed: Nov. 5, 2021

(30) Foreign Application Priority Data
Nov. 5, 2020 (SG) 10202011006Y

(51) Int. Cl. H01M 10/0569

(52) U.S. Cl. CPC H01M 10/0569; H01M 2300/0042

(57) ABSTRACT

The present disclosure describes an electrolyte for an electrochemical cell comprising Solvent A selected from cyclic carbonates, Solvent Group B comprising at least four solvents, each organic solvent having a Highest Occupied Molecular Orbital (HOMO) level between about −9 eV to about −7 eV, and an energy band gap of at least about 5 eV between the HOMO and Lowest Unoccupied Molecular Orbital (LUMO). Also provided herein is an electrochemical cell comprising the electrolyte disclosed herein.

### TECHNICAL FIELD

The present disclosure generally refers to electrolytes that are useful in low temperature applications. The present disclosure also generally refers to electrochemical cells comprising said electrolytes.

### BACKGROUND ART

Over the past three decades, lithium-ion batteries (LIBs) have gained great success in a large spectrum of portable electronic devices, which typically operate at room temperatures. Driven by the rapid growth of newly emerging applications, the demand for energy storage to survive and operate at sub-zero temperatures is surging. For example, electric vehicles may be parked at −30° C. in the winter of high-latitude regions, LIBs for telecom base stations on the submit of mountains, high-altitude drones may need to operate at temperatures as low as −50° C., and astrovehicles for space exploration may experience temperatures below −120° C. on Martian surfaces. Current commercial LIBs cannot survive under such harsh environmental conditions, considering the service temperature range of conventional LIBs is only between −20° C. to 60° C. Although thermal management systems may to some extent help batteries maintain relatively favourable and stable temperature for short-term operations, long-term storage at these extremely low temperatures will eventually cause irreversible mechanical damage to current LIBs.

A major bottle neck for the narrow service temperature range of LIBs comes from the freezing crystallization of electrolytes. For almost all LIBs electrolytes, ethylene carbonate (EC, m.p. 35-38° C.) is an important solvent component, which plays an important role in forming stable solid-electrolyte interphase (SEI) on the anode. This high melting point solvent tends to precipitate from electrolytes first when the temperature drops below 0° C. The decreased solvation ability of the remaining electrolyte leads to the further deposition of lithium salts. These precipitates not only lower the ionic conductivity of the electrolytes by increasing viscosity of the electrolyte, but also cover the surface of the electrodes leading to a dramatically increased interfacial impedance. Furthermore, crystals formed during freezing can damage the SEI film, separator and electrodes due to the change in density. Such precipitation and crystallization of electrolytes at low temperatures exert irreversible mechanical damage to cell internals, hindering the survival of LIBs under extreme temperature conditions. Therefore, lowering the freezing point of electrolytes is of great importance to extending the service temperature range of LIBs.

Thus, there is a need to provide electrolyte compositions for low-temperature applications.

### SUMMARY

In an aspect of the present disclosure, there is provided an electrolyte for an electrochemical cell comprising:
Solvent A selected from a cyclic carbonate; and
Solvent Group B comprising at least four organic solvents, each organic solvent having a Highest Occupied Molecular Orbital (HOMO) level between about −9 eV to about −7 eV, and an energy band gap of at least about 5 eV between the HOMO and Lowest Unoccupied Molecular Orbital (LUMO).

Advantageously, the electrolyte of the present disclosure may possess a very low freezing point (for example, <−100° C.), making it advantageously useful in low-temperature applications.

Also advantageously, the electrolyte of the present disclosure may become an amorphous solid at low temperatures instead of undergoing partial crystallisation. This makes the electrolyte superior in applications where partial crystallisation may spoil the contacting materials.

Further advantageously, the electrolyte of the present disclosure exhibits a high ionic conductivity at very low temperatures (for example, <−40° C.) which allows the performance in cells comprising said electrolytes to be maintained, even at very low temperatures.

Also advantageously, the electrolyte of the present disclosure may be easily applied to commercial cells, without additional steps or precaution.

In another aspect of the present disclosure, there is provided an electrochemical cell comprising the electrolyte disclosed herein.

Advantageously, the electrochemical cells comprising the electrolyte of the present disclosure is capable of functioning at low temperatures (for example, <−40° C.), making it superior over other conventional electrochemical cells.

Further advantageously, the electrochemical cells comprising the electrolyte of the present disclosure may require less maintenance, as the internal parts of the electrochemical cells may undergo less damage from crystallisation processes. This translates into lower costs and longevity of the electrochemical cell.

Also advantageously, the electrochemical cells comprising the electrolyte of the present disclosure may possess unprecedentedly higher energy capacity compared to cells comprising conventional electrolytes.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “organic solvent” refers to any organic compound that possess at least one carbon atom, and is present substantially as a liquid at room temperature or near room temperature.

As used herein, the term “electrochemical cell” refers to any cell comprising an electrolyte, cathode and anode and is capable of discharging a voltage.

As used herein, the term “alkyl” refers to C1-20 inclusive, e.g., an alkyl group of 1, 2, 3, 4, 5, 6, 7, 8, 9, 10, 11, 12, 13, 14, 15, 16, 17, 18, 19 or 20 carbons, linear (i.e., “straight-chain”), branched, or cyclic, saturated or unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms, e.g., an alkyl group of 1, 2, 3, 4, 5, 6, 7 or 8 carbons (i.e., a C1-8 alkyl). “Higher alkyl” refers to an alkyl group having about 10 to about 20 carbon atoms, e.g., alkyl groups of 10, 11, 12, 13, 14, 15, 16, 17, 18, 19 or 20 carbons. In some embodiments, “alkyl” refers, in particular, to C1-8 straight-chain alkyls, e.g., straight-chain alkyls of 1, 2, 3, 4, 5, 6, 7 or 8 carbons. In other embodiments, alkyl refers, in particular, to C1-8 branched-chain alkyls, e.g., branched-chain alkyls of 1, 2, 3, 4, 5, 6, 7 or 8 carbons. As used herein, the term “linear” refers to hydrocarbons containing at least 2 carbon atoms, and/or other heteroatoms (e.g., O, N, S, Se, P) that may be saturated or unsaturated, but does not contain any cyclic functional groups.

The term “cyclic” as used herein, refers to monocyclic or multicyclic (e.g., bicyclic, tricyclic) hydrocarbons containing from 3 to 12 carbon atoms, and/or other heteroatoms (e.g., O, N, S, Se, P) that may be saturated or unsaturated.

As used herein, the term “carbonate” refers to an organic derivative comprising the carbonate functional group (—O—C(O)—O—).

As used herein, the term “cyclic carbonate” refers to a carbonate derivative wherein the oxygens in alpha to the carbonyl are joined together by an optionally substituted alkyl residue, to form a cyclic aliphatic ring.

The term “ester” as used herein, refers to compounds comprising the ester functional group (—C(═O)—O—).

As used herein, the term “acid ester” refers to an ester that results from the combination of an acid with an alcohol.

As used herein, the term “cyclic acid ester” refers to an ester derivative wherein the oxygen and carbon in alpha to the carbonyl are joined together by an optionally substituted alkyl residue, to form a cyclic aliphatic ring.

The term “amide” as used herein, refers to compounds comprising the amide functional group (—C(═O)—NR—), wherein R represents an organic group or a hydrogen atom.

As used herein, the term “acid amide” refers to an amide that results from the combination of an acid with an amine.

As used herein, the term “cyclic acid amide” refers to an ester derivative wherein the carbon and nitrogen in alpha to the carbonyl are joined together by an optionally substituted alkyl residue, to form a cyclic aliphatic ring.

The term “ether” as used herein, refers to compounds comprising an ether functional group (R—O—R), wherein R represents an organic group.

The term “cyclic ether” as used herein, refers to a compound having an ether bond in a cyclic structure.

The term “carbamate” as used herein, refers to compounds comprising the carbamate functional group (—O—C(═O)—NR—) group structure, wherein R represents an organic group or hydrogen.

As used herein, the term “cyclic carbamate” refers to an ester derivative wherein the oxygen and nitrogen in alpha to the carbonyl are joined together by an optionally substituted alkyl residue, to form a cyclic aliphatic ring.

The term “nitriles” as used herein, refers to compounds comprising a —CN group.

The term “halogenated” as used herein, refers to compounds possessing at least one halogen atom, wherein the halogen atom may be selected from fluorine, chlorine, bromine, iodine or astatine, or any combinations thereof.

When compounded chemical names, e.g. “arylalkyl” and “arylimine” are used herein, they are understood to have a specific connectivity to the core of the chemical structure. The group listed farthest to the right (e.g. alkyl in “arylalkyl”), is the group that is directly connected to the core. Thus, an “arylalkyl” group, for example, is an alkyl group substituted with an aryl group (e.g. phenylmethyl (i.e., benzyl)) and the alkyl group is attached to the core. An “alkylaryl” group is an aryl group substituted with an alkyl group (e.g., p-methylphenyl (i.e., p-tolyl)) and the aryl group is attached to the core.

The term “equivolume” as used herein, refers to compositions or mixtures, wherein the individual liquid components of the mixtures are present in the same, substantially the same, or about the same volume.

The term “additive” as used herein, refers to a substance added in a small quantity (of not more than 5 wt %, or 5 vol %, or 5 wt/vol % or 5% of the total). The term “eutectic” refers to a mixture of substances that freezes at a temperature that is lower than the freezing points of the separate constituents.

As used herein, “amorphous” refers to a solid form of a molecule, atom, and/or ions that is not crystalline.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1a is a graph showing the Differential Scanning calorimetry (DSC) measurements for electrolytes of Table 1 heating from −170 to 20° C. The dashed line indicates the onset temperature of melting.

FIG. 1b is a graph showing the experimental and calculated freezing point of the electrolytes of Table 1. The insets are optical images of commercial (C1) and 10-mix electrolytes of Table 1 at −60° C.

FIG. 1c is a series of photographs showing electrolytes of Table 1 at −60 and −85° C.

FIG. 1d is a graph showing DSC curves of C1 and 10 mix electrolytes of Table 1 with increasing temperature.

FIG. 2a is a graph showing the Highest Occupied Molecular Orbital (HOMO) and Lowest Unoccupied Molecular Orbital (LUMO) energies of ethylene carbonate (EC), propylene carbonate (PC), ethyl methyl carbonate (EMC), diethyl carbonate (DEC), ethyl acetate (EA), butyl acetate (BA), methyl propionate (MP), ethyl propionate (EP), methyl butyrate (MB), propyl butyrate (PB) and fluoroethylene carbonate (FEC).

FIG. 2b is a graph showing a linear sweep voltammetry study of C2 and 10 mix electrolytes of Table 1 in a voltage range from 0 to 5.5 V.

FIG. 2c is a graph comparing ionic conductivity versus temperature of electrolytes of Table 1.

FIG. 2d is a graph comparing viscosity versus temperature of electrolytes of Table 1.

FIG. 2e is a graph showing an Arrhenius plot for ionic conductivity for Li⁺ diffusion of electrolytes of Table 1.

FIG. 2f is a graph showing an Arrhenius plot for activation energy for Li⁺ diffusion of electrolytes of Table 1.

FIG. 2g is a graph showing freezing point versus ionic conductivity (at −40° C.) of EC:DMC:DEC (C3), EC:PC:EMC, EC:DMC:EMC, EC:DMC:DEC:EB, EC:DMC:DEC:EMC and 10 mix electrolyte of Table 1.

FIG. 3a is a graph showing the discharging curves of Lithium Manganese Oxide/Lithium Titanate Oxide (LMO/LTO) full cell with C2 (EC:DEC) electrolyte of Table 1 at 0.1 C at various temperatures.

FIG. 3b is a graph showing the discharging curves of LMO/LTO full cell with 10 mix electrolyte of Table 1 at 0.1 C at various temperatures.

FIG. 3c is a graph showing the capacity retention of batteries based on the C1, C2, C3 and 10 mix electrolytes of Table 1 with decreasing temperature.

FIG. 3d is a series of photographs showing an image of a wristband powered by batteries with commercial (C2) and 10 mix electrolyte of Table 1 operating at −60° C. in an environmental chamber.

FIG. 3e is a graph showing the capacity retention at −60° C. of batteries based on EC:MB:BA EC:MP:PB, and 6 mix, 8 mix-a, 8 mix-b, and 10 mix electrolytes of Table 1.

FIG. 3f is a graph showing the cycling performance of a LMO/LTO cell based on the C2 and 10 mix electrolytes of Table 1 at −40° C.

FIG. 4a is a graph showing the isothermal titration calorimetry data for mixing propyl carbonate (PC) and ethyl acetate (EA) in both stirring and non-stirring modes.

FIG. 4b is a graph showing the corresponding heat production of mixing of PC and EA at varying molar ratios.

FIG. 4c is a graph showing the calculated entropy contribution during the mixing of PC and EA at varying molar ratios.

FIG. 4d is a schematic illustrating the microscopic changes between a general electrolyte comprising 2 solvents and an electrolyte comprising 10 solvents with decreasing temperatures.

FIG. 5 is a schematic illustrating the difference in crystallization process between a general electrolyte comprising 2 solvents and an electrolyte comprising 10 solvents.

FIG. 6a is a schematic illustrating how the crystallization of the electrolyte can cause possible damage to the separator and SEI films in LIBs. The star shapes represent the precipitates and crystals formed during freezing.

FIG. 6b is a graph showing how decreasing Gibbs free energy of liquid is an attractive strategy to lower the freezing point.

FIG. 6c is a graph showing how the eutectic point of the mixture is lower than the melting point of each solvent, wherein MP_{A} and MP_{B} refers to the melting points of Components A and B.

FIG. 6d is a graph showing the relationship between increasing the number of components and lowering the freezing point of electrolytes due to the entropy of mixing, wherein R is the gas constant, and x_{A} and x_{B} represent mole fractions of A and B respectively.

FIG. 7 is a graph showing the DSC curve of a general mixture comprising EC and EA.

FIG. 8 is a graph showing the ionic conductivity of a general electrolyte comprising 2 solvents (EC:EA at 1:9) at varying temperatures.

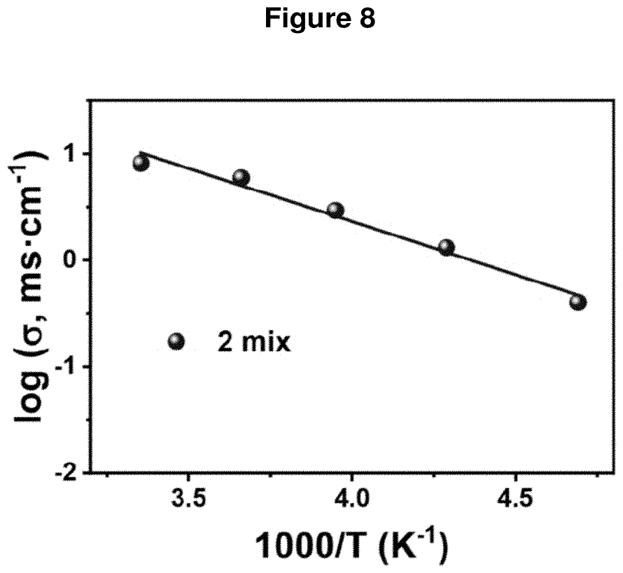

FIG. 9a is a graph showing the capacity retention of electrolytes of Table 1 at different temperatures.

FIG. 9b is a graph showing the capacity retention at −40° C. of batteries based on electrolytes of Table 1.

FIG. 10 is a graph comparing rate performance of LMO/LTO full cell with C3 and 10 mix electrolyte of Table 1 at −40° C.

FIG. 11a is a graph shows the specific capacity of C2 and 10 mix electrolytes of Table 1 at charging rate of 2 C at temperatures of −40° C. and −50° C., when Lithium Cobalt Oxide (LCO) is used as a cathode.

FIG. 11b is a graph showing the specific capacity of C2 and 10 mix electrolytes of Table 1 at charging rate of 2 C at temperatures of −40° C. and −50° C., when LiNi1/3Mn1/3Co1/3O2 (NMC111) is used as a cathode.

FIG. 12 is a graph showing the cycle performance of the a LMO/LTO full cell with 10 mix electrolyte of Table 1 at 2 C at room temperature.

FIG. 13 is a graph showing the computed changes in enthalpy, entropy and Gibbs free energy for mixing of PC and EA at various molar ratios.

FIG. 14 is a graph showing the change in freezing point, entropy and capacity retention at −40° C. (relative to that of room temperature) when the number of solvents in the electrolyte is increased.

### DETAILED DISCLOSURE OF DRAWINGS

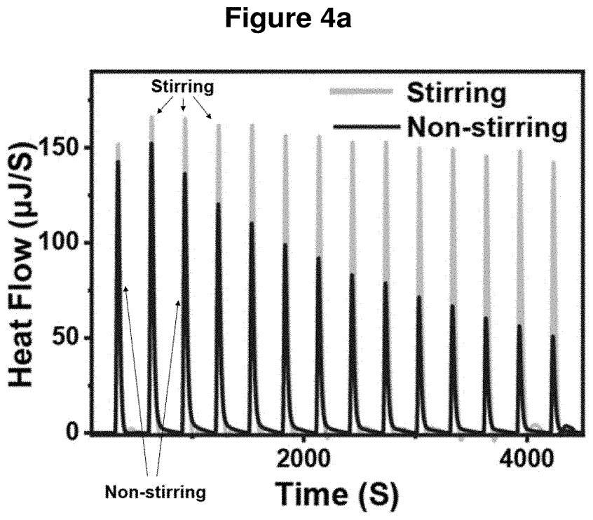

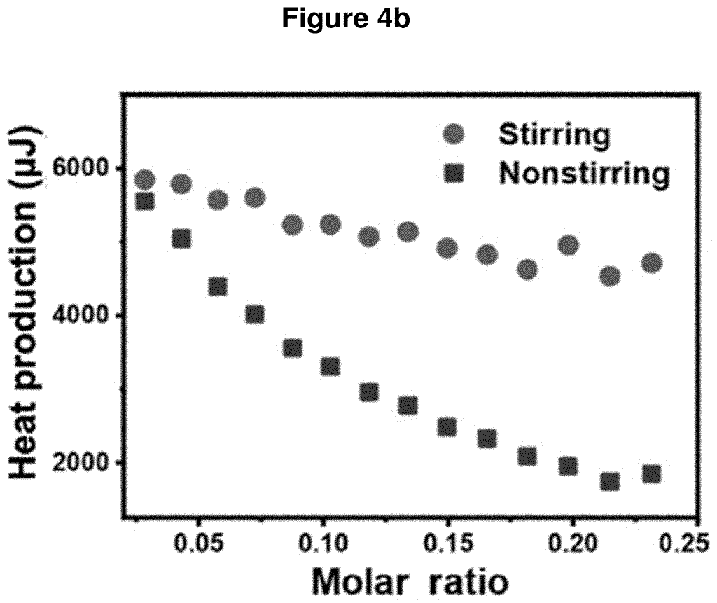

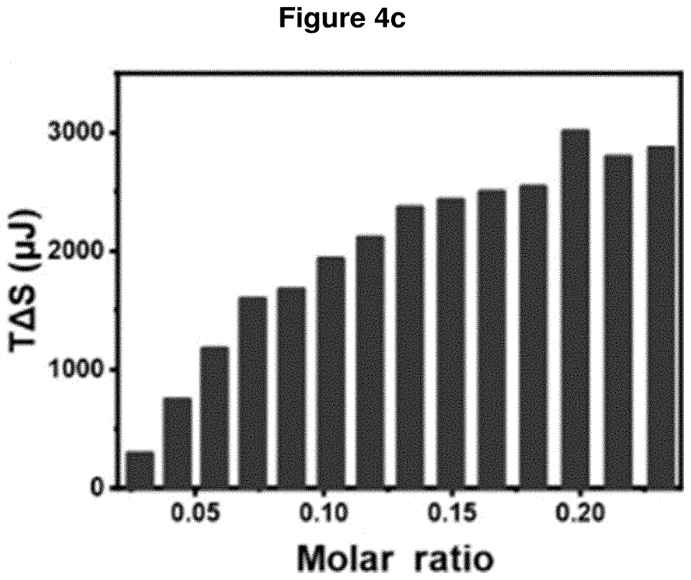

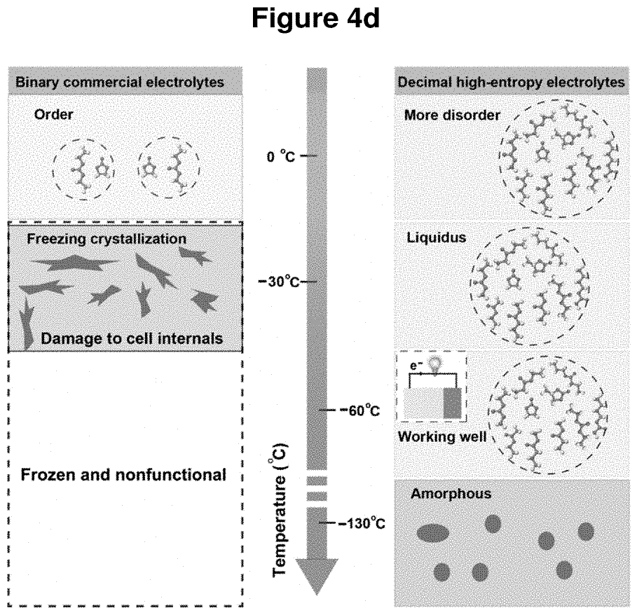

Referring to FIG. 4d, a binary solvent-based electrolyte system is more ordered relative to a multi-component electrolyte system. Thus, when exposed to low temperatures, EC possessing a high melting point is more inclined to precipitate out first, followed by lithium salts and other solvents in the form of orderly crystals. In comparison, for the decimal solvent-based electrolyte of the current invention, the mixture is more disordered and thus EC molecules are further apart from each other, leading to a depression in freezing point, down to as −10° C. Meanwhile, the decimal solvent-based electrolyte favours the formation of an amorphous solid.

### DETAILED DISCLOSURE OF EMBODIMENTS

The present disclosure refers to electrolytes possessing extremely low freezing points. The electrolyte may comprise one solvent A selected from a cyclic carbonate, and a solvent group B comprising at least four solvents, each solvent having a Highest Occupied Molecular Orbital (HOMO) level between about −9 eV to about −7 eV, and an energy band gap of at least about 5 eV between the HOMO and Lowest Unoccupied Molecular Orbital (LUMO).

The HOMO level of the solvents in the electrolytes may be between about −9 eV to about −7 eV, between about −8.5 eV to about −7 eV, between about −8 eV to about −7 eV, between about −7.5 eV to about −7 eV, between about −9 eV to about −7.5 eV, between about −8.5 eV to about −7.5 eV, between about −8 eV to about −7.5 eV, between about −9 eV to about −8 eV, between about −8.5 eV to about −8 eV, between about −9 eV to about −8.5 eV, about −9 eV, about −8.9 eV, about −8.8 eV, about −8.7 eV, about −8.6 eV, about −8.5 eV, about −8.4 eV, about −8.3 eV, about −8.2 eV, about −8.1 eV, about −8 eV, about −7.9 eV, about −7.8 eV, about −7.7 eV, about −7.6 eV, about −7.5 eV, about −7.4 eV, about −7.3 eV, about −7.2 eV, about −7.1 eV, about −7 eV, or any value or range therebetween.

The LUMO level of the solvents in the electrolyte may be between about 0 eV to about 1.5 eV, between about 0.5 eV to about 1.5 eV, between about 1 eV to about 1.5 eV, between about 0 eV to about 1 eV, between about 0.5 eV to about 1 eV, between about 0 eV to about 0.5 eV, about 0 eV, about 0.1 eV, about 0.2 eV, about 0.3 eV, about 0.4 eV, about 0.5 eV, about 0.6 eV, about 0.7 eV, about 0.8 eV, about 0.9 eV, about 1 eV, about 1.1 eV, about 1.2 eV, about 1.3 eV, about 1.4 eV, about 1.5 eV, or any value or range therebetween.

The energy band gap between the HOMO and Lowest Unoccupied Molecular Orbital (LUMO) of each solvent in the electrolyte may be at least about 5 eV, at least about 5.1 eV, at least about 5.2 eV, at least about 5.4 eV, at least about 5.5 eV, at least about 5.6 eV, at least about 5.7 eV, at least about 5.8 eV, at least about 5.9 eV, at least about 6 eV, at least about 6.1 eV, at least about 6.2 eV, at least about 6.3 eV, at least about 6.4 eV, at least about 6.5 eV, at least about 6.6 eV, at least about 6.7 eV, at least about 6.8 eV, at least about 6.9 eV, at least about 7 eV, at least about 7.1 eV, at least about 7.2 eV, at least about 7.3 eV, at least about 7.4 eV, at least about 7.5 eV, at least about 7.6 eV, at least about 7.7 eV, at least about 7.8 eV, at least about 7.9 eV, at least about 8 eV, at least about 8.1 eV, at least about 8.2 eV, at least about 8.3 eV, at least about 8.4 eV, at least about 8.5 eV, at least about 8.6 eV, at least about 8.7 eV, at least about 8.8 eV, at least about 8.9 eV, at least about 9 eV, at least about 9.1 eV, at least about 9.2 eV, at least about 9.3 eV, at least about 9.4 eV, at least about 9.5 eV, at least about 9.6 eV, at least about 9.7 eV, at least about 9.8 eV, at least about 9.9 eV, at least about 10 eV, at least about 10.1 eV, at least about 10.2 eV, at least about 10.3 eV, at least about 10.4 eV, at least about 10.5 eV, at least about 10.6 eV, at least about 10.7 eV, at least about 10.8 eV, at least about 10.9 eV, at least about 11 eV, or any value or range therebetween.

The energy band gap between the HOMO and Lowest Unoccupied Molecular Orbital (LUMO) of each solvent in the electrolyte may be in the range of about 5 eV to about 10 eV, about 5 eV to about 9 eV, about 5 eV to about 8 eV, about 5 eV to about 7 eV, about 5 eV to about 6 eV, about 6 eV to about 10 eV, about 7 eV to about 10 eV, about 8 eV to about 10 eV, about 9 eV to about 10 eV, or any value or range therebetween. In a preferred embodiment, the organic solvents of the electrolyte should be selected based on HOMO and LUMO levels within about 1.0 eV of ethyl carbonate (EC). This advantageously results in good cyclability of the general solvent mixture. The selection of the HOMO and LUMO levels advantageously ensures stable operation and cycling of metal ion (such as lithium ion) batteries.

Solvent A may be a cyclic carbonate. Solvent A may be any cyclic compound comprising a ring containing a carbonate functional group (—O—C(O)—O—) as part of the ring. Solvent A may be ethylene carbonate, propylene carbonate, vinylene carbonate, butylene carbonate, or vinylethylene carbonate.

Solvent Group B may comprise at least four organic solvents, at least five organic solvents, at least six organic solvents, at least seven organic solvents, at least eight organic solvents, or at least organic nine solvents.

The electrolyte may contain a total of five organic solvents, six organic solvents, seven organic solvents, eight organic solvents, nine organic solvents, ten organic solvents, eleven organic solvents, or twelve organic solvents.

Solvent Group B may comprise solvents selected from the group consisting of cyclic carbonates, linear carbonates, halogenated cyclic or linear carbonates, cyclic or linear acid esters, halogenated cyclic or linear acid esters, cyclic or linear acid amides, halogenated cyclic or linear acid amides, cyclic or linear ethers, halogenated cyclic or linear ethers, cyclic or linear esters, halogenated cyclic or linear esters, cyclic or linear carbamates, halogenated cyclic or linear carbamates, and nitriles.

Solvent Group B may comprise solvents selected from the group consisting of cyclic carbonates, linear carbonates, and linear esters.

Solvent Group B may comprise solvents selected from the group consisting of ethylene carbonate, propylene carbonate, vinylene carbonate, butylene carbonate, vinylethylene carbonate, propylene carbonate, dimethyl carbonate, ethyl methyl carbonate, diethyl carbonate, ethyl acetate, butyl acetate, methyl propionate, ethyl propionate, methyl butyrate, and propyl butyrate.

The electrolyte may comprise Solvent A in a range of about 5 vol % to about 20 vol %, about 5 vol % to about 19 vol %, about 5 vol % to about 18 vol %, about 5 vol % to about 17 vol %, about 5 vol % to about 16 vol %, about 5 vol % to about 15 vol %, about 5 vol % to about 14 vol %, about 5 vol % to about 13 vol %, about 5 vol % to about 12 vol %, about 5 vol % to about 11 vol %, about 5 vol % to about 10 vol %, about 5 vol % to about 9 vol %, about 5 vol % to about 8 vol %, about 5 vol % to about 7 vol %, about 5 vol % to about 6 vol %, about 6 vol % to about 20 vol %, about 7 vol % to about 20 vol %, about 8 vol % to about 20 vol %, about 9 vol % to about 20 vol %, about 10 vol % to about 20 vol %, about 11 vol % to about 20 vol %, about 12 vol % to about 20 vol %, about 13 vol % to about 20 vol %, about 14 vol % to about 20 vol %, about 15 vol % to about 20 vol %, about 16 vol % to about 20 vol %, about 17 vol % to about 20 vol %, about 18 vol % to about 20 vol %, about 19 vol % to about 20 vol %, about 5 vol %, about 5.5 vol %, about 6 vol %, about 6.5 vol %, about 7 vol %, about 7.5 vol %, about 8 vol %, about 8.5 vol %, about 9 vol %, about 9.5 vol %, about 10 vol %, about 10.5 vol %, about 11 vol %, about 11.5 vol %, about 12 vol %, about 12.5 vol %, about 13 vol %, about 13.5 vol %, about 14 vol %, about 14.5 vol %, about 15 vol %, about 15.5 vol %, about 16 vol %, about 16.5 vol %, about 17 vol %, about 17.5 vol %, about 18 vol %, about 18.5 vol %, about 19 vol %, about 19.5 vol %, about 20 vol %, or any value or range therebetween.

In some embodiments, one Solvent Group B organic solvent may be equivolume or substantially equivolume to another Solvent Group B organic solvent. For example, if one Solvent Group B solvent is present in X vol %, then at least one other Solvent Group B organic solvent would be present in about X vol %.

In other embodiments, all Solvent Group B organic solvents may be equivolume or substantially equivolume to each other. For example, if there are four organic solvents in Solvent Group B and one organic solvent is present in X vol %, then each of the other three organic solvents in Solvent Group B would be present in about X vol %.

In other embodiments, one Solvent Group B organic solvent may be equivolume or substantially equivolume to the Solvent A organic solvent. For example, if Solvent A is present in X vol %, then at least one Solvent Group B organic solvent would be present in about X vol %.

In some embodiments, each Solvent Group B organic solvent may be equivolume or substantially equivolume to the Solvent A organic solvent. For example, if Solvent A is present in X vol % and if there are four organic solvents in Solvent Group B, then each of the four organic solvents in Solvent Group B would be present in about X vol %.

The electrolyte may also comprise solvents from Solvent Group B in a certain vol % depending on the number of solvents in the electrolyte. The solvents may be present in the electrolyte in about 8 vol %, about 9 vol %, about 10 vol %, about 11 vol %, about 12 vol %, about 13 vol %, about 14 vol %, about 15 vol %, about 16 vol %, about 17 vol %, about 18 vol %, about 19 vol %, about 20 vol %.

The solvents selected in Solvent Group B may be equivolume or substantially equivolume to each other. By “substantially equivolume”, it is meant that the difference in volume may be about 0.5 vol %, about 1 vol %, about 1.5 vol %, about 2 vol %, about 2.5 vol %, about 3 vol %, about 3.5 vol %, about 4 vol %, about 4.5 vol %, or about 5 vol %.

The solvents selected in Solvent Group B may be equivolume or substantially equivolume to Solvent A in the electrolyte. By “substantially equivolume”, it is meant that the difference in volume may be about 0.5 vol %, about 1 vol %, about 1.5 vol %, about 2 vol %, about 2.5 vol %, about 3 vol %, about 3.5 vol %, about 4 vol %, about 4.5 vol %, or about 5 vol %.

The electrolyte may comprise ethylene carbonate as Solvent A and at least four other solvents taken from Solvent Group B. The electrolyte may comprise ethylene carbonate as Solvent A, propylene carbonate as one of the solvents of Solvent Group B, and at least three other solvents from Solvent Group B. The electrolyte may comprise ethylene carbonate as Solvent A, propylene carbonate as one of the solvents of Solvent Group B, and three other solvents from Solvent Group B.

The electrolyte may comprise ethylene carbonate as Solvent A and at least five other solvents taken from Solvent Group B. The electrolyte may comprise ethylene carbonate as Solvent A, propylene carbonate as one of the solvents of Solvent Group B, and at least four other solvents from Solvent Group B. The electrolyte may comprise ethylene carbonate as Solvent A, propylene carbonate as one of the solvents of Solvent Group B, and four other solvents from Solvent Group B.

The electrolyte may comprise ethylene carbonate as Solvent A and at least six other solvents taken from Solvent Group B. The electrolyte may comprise ethylene carbonate as Solvent A, propylene carbonate as one of the solvents of Solvent Group B, and at least five other solvents from Solvent Group B. The electrolyte may comprise ethylene carbonate as Solvent A, propylene carbonate as one of the solvents of Solvent Group B, and five other solvents from Solvent Group B.

The electrolyte may comprise ethylene carbonate as Solvent A and at least seven other solvents taken from Solvent Group B. The electrolyte may comprise ethylene carbonate as Solvent A, propylene carbonate as one of the solvents of Solvent Group B, and at least six other solvents from Solvent Group B. The electrolyte may comprise ethylene carbonate as Solvent A, propylene carbonate as one of the solvents of Solvent Group B, and six other solvents from Solvent Group B.

The electrolyte may comprise ethylene carbonate as Solvent A and at least eight other solvents taken from Solvent Group B. The electrolyte may comprise ethylene carbonate as Solvent A, propylene carbonate as one of the solvents of Solvent Group B, and at least seven other solvents from Solvent Group B. The electrolyte may comprise or ethylene carbonate as Solvent A, propylene carbonate as one of the solvents of Solvent Group B, and seven other solvents from Solvent Group B.

The electrolyte may comprise ethylene carbonate as Solvent A and at least nine other solvents taken from Solvent Group B. The electrolyte may comprise ethylene carbonate as Solvent A, propylene carbonate as one of the solvents of Solvent Group B, and at least eight other solvents from Solvent Group B. The electrolyte may comprise ethylene carbonate as Solvent A, propylene carbonate as one of the solvents of Solvent Group B, and eight other solvents from Solvent Group B.

The electrolyte may comprise ethylene carbonate as Solvent A and at least ten other solvents taken from Solvent Group B. The electrolyte may comprise ethylene carbonate as Solvent A, propylene carbonate as one of the solvents of Solvent Group B, and at least nine other solvents from Solvent Group B. The electrolyte may comprise ethylene carbonate as Solvent A, propylene carbonate as one of the solvents of Solvent Group B, and nine other solvents from Solvent Group B.

The electrolyte may comprise ethylene carbonate as Solvent A and at least eleven other solvents taken from Solvent Group B. The electrolyte may comprise ethylene carbonate as Solvent A, propylene carbonate as one of the solvents of Solvent Group B, and at least ten other solvents from Solvent Group B. The electrolyte may comprise ethylene carbonate as Solvent A, propylene carbonate as one of the solvents of Solvent Group B, and ten other solvents from Solvent Group B.

The electrolyte may also consist of ethylene carbonate selected from Solvent Group A, and 3, or at least 3, or 4, or at least 4, or 5, or at least 5, or 6, or at least 6, or 7, or at least 7, or 8, or at least 8, or 9, or at least 9 solvents, 10, or at least 10 solvents, 11, or at least 11 solvents selected from Solvent Group B, wherein Solvent Group B may comprise propylene carbonate, ethyl methyl carbonate, diethyl carbonate, ethyl acetate, butyl acetate, methyl propionate, ethyl propionate, methyl butyrate, and/or propyl butyrate.

In some embodiments, the electrolyte may comprise ethylene carbonate, propylene carbonate, diethyl carbonate, ethyl methyl carbonate, ethyl propionate and ethyl acetate. In other embodiments, the electrolyte may comprise ethylene carbonate, propylene carbonate, diethyl carbonate, ethyl methyl carbonate, ethyl propionate, ethyl acetate, methyl butyrate and butyl acetate. In further embodiments, the electrolyte may comprise ethylene carbonate, propylene carbonate, diethyl carbonate, ethyl methyl carbonate, ethyl propionate, ethyl acetate, methyl butyrate and propyl butyrate. In other embodiments, the electrolyte may comprise ethylene carbonate, propylene carbonate, diethyl carbonate, ethyl methyl carbonate, ethyl propionate, ethyl acetate, methyl butyrate, butyl acetate, methyl propionate and propyl butyrate.

In some embodiments, the electrolyte may comprise ethylene carbonate as Solvent A, and propylene carbonate, among other solvents, from Solvent Group B. The total proportion of ethyl carbonate and propylene carbonate may make up about 15 vol %, at least about 15%, about 16%, or at least about 16%, about 17%, or at least about 17%, about 18%, or at least about 18%, about 19%, or at least about 19%, about 20%, or at least about 20%, about 21%, or at least about 21%, about 22%, or at least about 22%, about 23%, or at least about 23%, about 24%, or at least about 24%, about 25%, or at least about 25%, about 26%, or at least about 26%, about 27%, or at least about 27%, about 28%, or at least about 28%, about 29%, or at least about 29%, about 30%, or at least about 30% of the total volume of the electrolyte.

In some embodiments, the electrolyte may further comprise additives. In some embodiments the additives may be chosen from the group consisting of halogenated cyclic carbonates, non-halogenated cyclic carbonates, halogenated linear carbonates, non-halogenated linear carbonates, unsaturated cyclic carbonates, unsaturated linear carbonates and lithium salts. The additive may be fluoroethylene carbonate (FEC), lithium oxalate, lithium bis(oxalato)borate, vinylene carbonate, lithium difluoro(oxalato) borate, lithium tetrafluoro(oxalato) phosphate, vinylethylene carbonate, dimethyl pyrocarbonate, diethyl pyrocarbonate, methylethyl pyrocarbonate, dimethyl sulfite, diethyl sulfite, ethylmethyl sulfite, or a combination thereof. The additive may be a lithium salt. In some embodiments, the lithium salt may be lithium hexafluorophosphate, lithium bis(oxalate)borate, lithium difluorooxolato borate, lithium hexafluoroarsenate (V), lithium hexafluorophosphate, lithium bis(trifluoromethanesulfonyl)imide, lithium bis(perfluoroethanesulfonyl)imide, lithium tetrafluoroborate, lithium perchlorate, lithium trifluoromethanesulfonate, lithium tris(trifluoromethanesulfonyl)methide, lithium bis(oxalato)borate, or any combinations or mixtures thereof.

In some embodiments, the concentration of the lithium salt in the electrolyte may be in the range of about 0.1 M to about 3 M, about 0.2 M to about 3 M, about 0.3 M to about 3 M, about 0.4 M to about 3 M, about 0.5 M to about 3 M, about 0.6 M to about 3 M, about 0.7 M to about 3 M, about 0.8 M to about 3 M, about 0.9 M to about 3 M, about 1.0 M to about 3 M, about 1.1 M to about 3 M, about 1.2 M to about 3 M, about 1.3 M to about 3 M, about 1.4 M to about 3 M, about 1.5 M to about 3 M, about 1.6 M to about 3 M, about 1.7 M to about 3 M, about 1.8 M to about 3 M, about 1.9 M to about 3 M, about 2.0 M to about 3 M, about 2.1 M to about 3 M, about 2.2 M to about 3 M, about 2.3 M to about 3 M, about 2.4 M to about 3 M, about 2.5 M to about 3 M, about 2.6 M to about 3 M, about 2.7 M to about 3 M, about 2.8 M to about 3 M, about 2.9 M to about 3 M, about 0.1 M to about 2.9 M, about 0.1 M to about 2.8 M, about 0.1 M to about 2.7 M, about 0.1 M to about 2.6 M, about 0.1 M to about 2.5 M, about 0.1 M to about 2.4 M, about 0.1 M to about 2.3 M, about 0.1 M to about 2.2 M, about 0.1 M to about 2.1 M, about 0.1 M to about 2 M, about 0.1 M to about 1.9 M, about 0.1 M to about 1.8 M, about 0.1 M to about 1.7 M, about 0.1 M to about 1.6 M, about 0.1 M to about 1.5 M, about 0.1 M to about 1.4 M, about 0.1 M to about 1.3 M, about 0.1 M to about 1.2 M, about 0.1 M to about 1.1 M, about 0.1 M to about 1 M, about 0.1 M to about 0.9 M, about 0.1 M to about 0.8 M, about 0.1 M to about 0.7 M, about 0.1 M to about 0.6 M, about 0.1 M to about 0.5 M, about 0.1 M to about 0.4 M, about 0.1 M to about 0.3 M, about 0.1 M to about 0.2 M, about 1.0 M to about 3 M, about 1.5 M to about 3 M, about 2.0 M to about 3 M, about 2.5 M to about 3 M, about 0.5 M to about 2.5 M, about 0.5 M to about 2 M, about 0.5 M to about 1.5 M, about 0.5 M to about 1 M, about 0.5 M to about 3 M, about 0.1 M, about 0.2 M, about 0.3 M, about 0.4 M, about 0.5 M, about 0.6 M, about M, about 0.7 M, about 0.8 M, about 0.9 M, about 1 M, about 1.1 M, about 1.2 M, about 1.3 M, about 1.4 M, about 1.5 M, about 1.6 M, about 1.7 M, about 1.8 M, about 1.9 M, about 2 M, about 2.1 M, about 2.2 M, about 2.3 M, about 2.4 M, about 2.5 M, about 2.6 M, about 2.7 M, about 2.8 M, about 2.9 M, about 3 M, about 3.1 M, about 3.2 M, about 3.3 M, about 3.4 M, about 3.5 M, at least 0.1 M, at least 0.2 M, at least 0.3 M, at least 0.4 M, at least 0.5 M, at least 0.6 M, at least 0.7 M, at least 0.8 M, at least 0.9 M, at least 1 M, at least 1.1 M, at least 1.2 M, at least 1.3 M, at least 1.4 M, at least 1.5 M, at least 1.6 M, at least 1.7 M, at least 1.8 M, at least 1.9 M, at least 2 M, at least 2.1 M, at least 2.2 M, at least 2.3 M, at least 2.4 M, at least 2.5 M, at least 2.6 M, at least 2.7 M, at least 2.8 M, at least 2.9 M, at least 3 M, at least 3.1 M, at least 3.2 M, at least 3.3 M, at least 3.4 M, at least 3.5 M. or any value or range therebetween.

In some embodiments, the additive added may either be liquid or solid. In some embodiments the additive may be added in the range of about 0.5 vol % to about 5 vol %, about 1 vol % to about 5 vol %, about 1.5 vol % to about 5 vol %, about 2 vol % to about 5 vol %, about 2.5 vol % to about 5 vol %, about 3 vol % to about 5 vol %, about 3.5 vol % to about 5 vol %, about 4 vol % to about 5 vol %, about 4.5 vol % to about 5 vol %, about 0.5 vol % to about 4.5 vol %, about 0.5 vol % to about 4 vol %, about 0.5 vol % to about 3.5 vol %, about 0.5 vol % to about 3 vol %, about 0.5 vol % to about 2.5 vol %, about 0.5 vol % to about 2 vol %, about 0.5 vol % to about 1.5 vol %, about 0.5 vol % to about 1 vol %, about 0.5 vol %, about 1 vol %, about 1.5 vol %, about 2 vol %, about 2.5 vol %, about 3 vol %, about 3.5 vol %, about 4 vol %, about 4.5 vol %, about 5 vol %, or any value or range therebetween, in weight by volume of the total electrolyte.

In some embodiments, the freezing point of the electrolyte may be in the range of about −10° C. to about −150° C., about −20° C. to about −150° C., about −25° C. to about −150° C., about −30° C. to about −150° C., about −35° C. to about −150° C., about −40° C. to about −150° C., about −45° C. to about −150° C., about −50° C. to about −150° C., about −55° C. to about −150° C., about −60° C. to about −150° C., about −65° C. to about −150° C., about −70° C. to about −150° C., about −75° C. to about −150° C., about −80° C. to about −150° C., about −85° C. to about −150° C., about −90° C. to about −150° C., about −95° C. to about −150° C., about −100° C. to about −150° C., about −105° C. to about −150° C., about −110° C. to about −150° C., about −115° C. to about −150° C., about −120° C. to about −150° C., about −125° C. to about −150° C., about −130° C. to about −150° C., about −135° C. to about −150° C., about −140° C. to about −150° C., about −145° C. to about −150° C., about −10° C., about −20° C., about −30° C., about −40° C., about −50° C., about −60° C., about −70° C., about −80° C., about −90° C., about −100° C., about −110° C., about −120° C., about −130° C., about −140° C., about −150° C., or any value or range therebetween. The freezing point of the electrolyte may be about −100° C. and lower.

The electrolyte may exhibit enhanced ionic conductivity. In some embodiments, the ionic conductivity of the electrolyte of the present invention may be about 0.1 mS·cm⁻¹, about 0.2 mS·cm⁻¹, about 0.3 mS·cm⁻¹, about 0.4 mS·cm⁻¹, about 0.5 mS·cm⁻¹, about 0.6 mS·cm⁻¹, about 0.7 mS·cm⁻¹, about 0.8 mS·cm⁻¹, about 0.9 mS·cm⁻¹, about 1 mS·cm⁻¹, about 1.5 mS·cm⁻¹, about 2 mS·cm⁻¹, about 2.5 mS·cm⁻¹, about 3 mS·cm⁻¹, about 3.5 mS·cm⁻¹, about 4 mS·cm⁻¹, about 4.5 mS·cm⁻¹, about 5 mS·cm⁻¹, about 5.5 mS·cm⁻¹, about 6 mS·cm⁻¹, about 6.5 mS·cm⁻¹, about 7 mS·cm⁻¹, about 7.5 mS·cm⁻¹, about 8 mS·cm⁻¹, about 8.5 mS·cm⁻¹, about 9 mS·cm⁻¹, about 9.5 mS·cm⁻¹, about 10 mS·cm⁻¹, about 10.5 mS·cm⁻¹, about 11 mS·cm⁻¹, about 11.5 mS·cm⁻¹, about 12 mS·cm⁻¹, about 12.5 mS·cm⁻¹, about 13 mS·cm⁻¹, about 13.5 mS·cm⁻¹, about 14 mS·cm⁻¹, about 14.5 mS·cm⁻¹, about 15 mS·cm⁻¹.

The present disclosure further refers to an electrochemical cell, comprising an electrolyte, wherein the electrolyte comprises:
Solvent A selected from cyclic carbonate; and
Solvent Group B comprising at least four organic solvents, each organic solvent having a Highest Occupied Molecular Orbital (HOMO) level between about −9 eV to about −7 eV, and an energy band gap of at least about 5 eV between the HOMO and Lowest Unoccupied Molecular Orbital (LUMO).

An electrochemical cell comprising an electrolyte of the present invention may possess superior performance at low temperatures. In some embodiments, the electrochemical cell disclosed herein may be capable of performing at temperatures of about −10° C., about −20° C., about −30° C., about −40° C., about −50° C., about −60° C., about −70° C., about −80° C., about −90° C., about −100° C., about −110° C., about −120° C., about −130° C., about −140° C., about −150° C. In other embodiments, the electrochemical cell disclosed herein may be capable of performing at temperatures below −10° C., below −20° C., below −30° C., below −40° C., below −50° C., below −60° C., below −70° C., below −80° C., below −90° C., below −100° C., below −110° C., below −120° C., below −130° C., below −140° C., below −150° C.

An electrochemical cell comprising the electrolyte of the present invention may comprise different compatible electrodes that the electrolyte is compatible with. The electrolyte material may be made from Lithium Manganese Oxide (LMO), Lithium Cobalt Oxide (LCO), NMC111, Lithium Titanium Oxide (LTO), LCAO, lithium-rich layered cathode, layered lithium transition metal oxide, lithium nickel manganese oxide or graphite.

### EXAMPLES

Non-limiting examples of the invention will be further described in greater detail by reference to specific examples, which should not be construed as in any way limiting the scope of the invention.

Materials

LiMn₂O₄(LMO) microparticles, acetylene black, electrolytes of 1.0 M LiPF₆ in EC:DMC (1:1), EC:DEC (1:1), NMC111 and LCO were obtained from MTI Corporation. (Richmond, Calif., USA) with metal impurity ≤25 ppb. Li4Ti5O12 (LTO) powders were purchased from Xing Neng New Materials Co., Ltd. (Guang Yuan, Sichuan, China). Poly(vinylidene fluoride) (PVDF) was purchased from Arkema KYNAR 761 (Colombes, Hauts-de-Seine, France). EC, propylene carbonate (PC), DMC, DEC, EMC, ethyl propionate (EP), EA, methyl butanoate (MB), butyl acetate (BA), methyl propionate (MP), propyl butyrate (PB), fluoroethylene carbonate (FEC), and electrolyte of 1.0 M LiPF6 in EC:DMC:DEC (1:1:1) were purchased from Sigma-Aldrich Inc. (St. Louis, Mo., USA).

### Example 1: Electrolyte Preparation

To systematically evaluate the impact of the number of solvents on the properties of electrolytes, a series of electrolytes with a varied number of solvents (denoted as n mix) and three commercial electrolytes were used for comparison (Table 1).

TABLE 1

| Electrolyte no. | Solvent component (Ratio of 1:1 except EC) |
|---|---|
| C1 (commercial) | EC:DMC (1:1) |
| C2 (commercial) | EC:DEC (1:1) |
| C3 (commercial) | EC:DMC:DEC (1:1:1) |
| 2 mix | EC:EMC |
| 4 mix | EC:DEC:PC:EMC |
| 6 mix | EC:DEC:PC:EMC:EP:EA |
| 8 mix-a | EC:DEC:PC:EMC:EP:EA:MB:BA |
| 8 mix-b | EC:DEC:PC:EMC:EP:EA:MP:PB |
| 10 mix | EC:DEC:PC:EMC:EP:EA:MB:BA:MP:PB |

In this example, the amount of EC was fixed at 10% in volume and the volume ratio of others was maintained at 1:1. To ensure a good cyclability of battery, the total fraction of EC and PC was kept at more than 20%, considering these two components play a vital role in the formation of a stable SEI.

The other organic solvents of the electrolyte were selected based on HOMO and LUMO levels within about 1.0 eV of ethyl carbonate (EC). Considering that some solvents possess a lower LUMO compared with EC, FEC was used as an additive to promote the formation of a stable SEI.

Solvent proportions of exemplified the electrolytes of this invention are shown in Table 2. The physical properties of the solvents (freezing point, viscosity) are further detailed in Table 3.

TABLE 2

| Electrolyte | Solvent components | | | | | | | | | |
|---|---|---|---|---|---|---|---|---|---|---|
| no. | EC | DEC | PC | EMC | EP | EA | MB | BA | MP | BA |
| 2 mix | 10% | | | 90% | | | | | | |
| 4 mix | 10% | 30% | 30% | 30% | | | | | | |
| 6 mix | 10% | 18% | 18% | 18% | 18% | 18% | | | | |
| 8 mix-a | 10% | 12.9% | 12.9% | 12.9% | 12.9% | 12.9% | 12.9% | 12.9% | | |
| 8 mix-b | 10% | 12.9% | 12.9% | 12.9% | 12.9% | 12.9% | | | 12.9% | 12.9% |
| 10 mix | 10% | 10% | 10% | 10% | 10% | 10% | 10% | 10% | 10% | 10% |

TABLE 3

| | Melting point | Viscosity |
|---|---|---|
| Solvent | Tₘ/° C. | η/cP 25° C. |
| Ethylene carbonate (EC) | 36.4 | 1.90 (40° C.) |
| Dimethyl carbonate (DMC) | 4.6 | 0.63 |
| Propylene carbonate (PC) | −48.8 | 2.53 |
| Ethyl methyl carbonate (EMC) | −53 | 0.65 |
| Diethyl carbonate (DEC) | −74.3 | 0.75 |
| Ethyl acetate (EA) | −84 | 0.45 |
| Butyl acetate (BA) | −78 | 0.68 |
| Methyl propionate (MP) | −87.5 | 0.431 |
| Ethyl propionate (EP) | −73 | |
| Methyl butanoate (MB) | −85.8 | 0.541 |
| Propyl butyrate (PB) | −95.2 | |

### Example 2: Freezing Point Determination

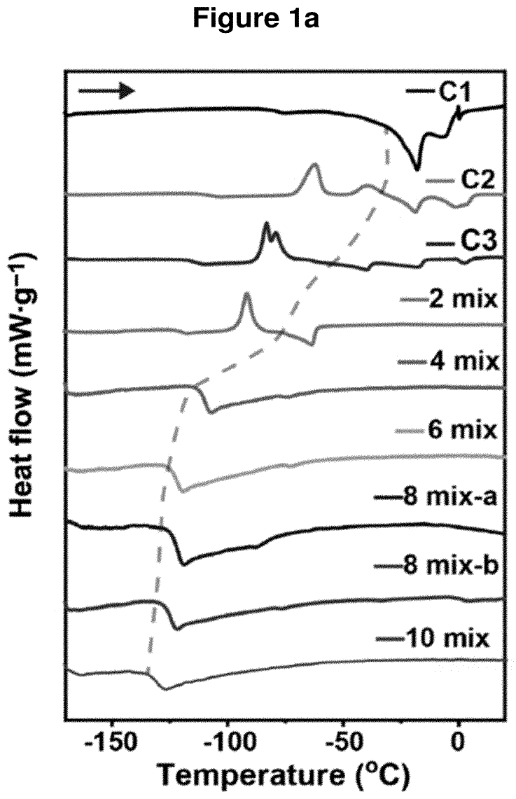

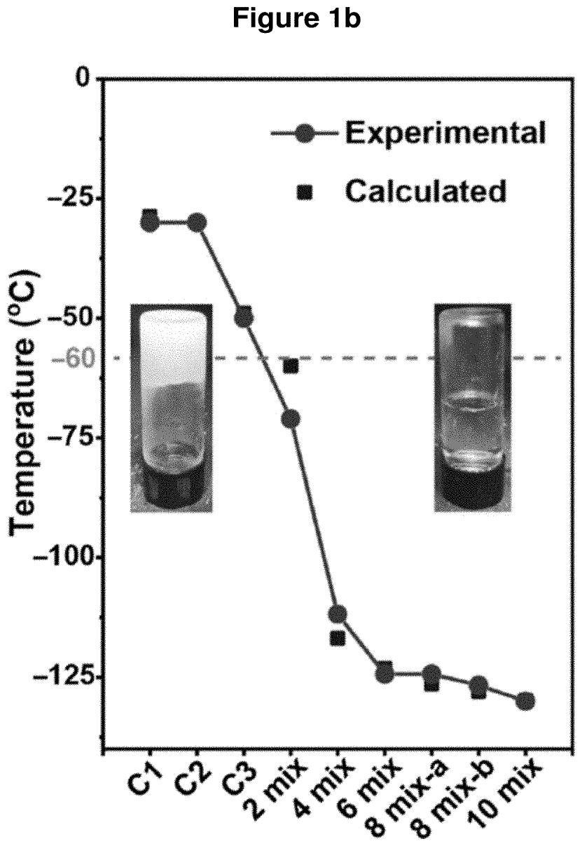

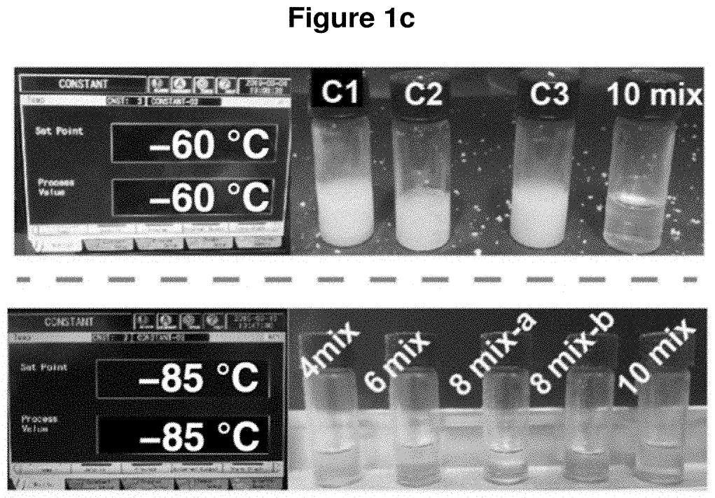

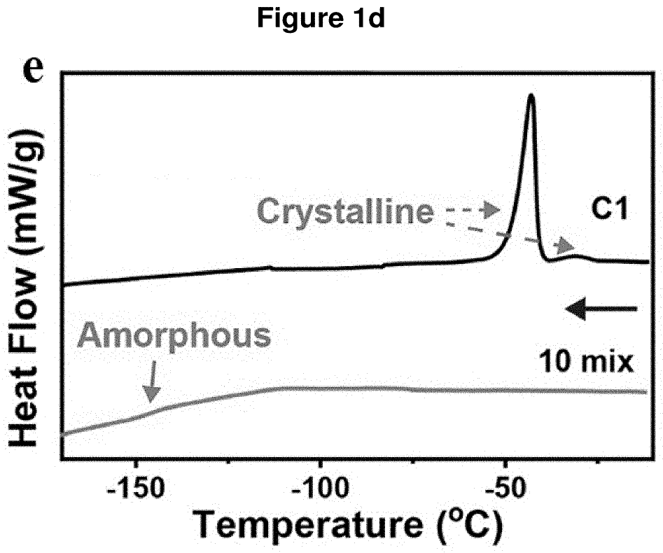

Differential scanning calorimetry (DSC) was used to investigate the freezing point of the electrolytes through a DSC 2010 differential scanning calorimeter (TA Instruments, New Castle, Del., USA). During measurement, the sealed pan with electrolyte was first cooled down to −170° C. at the rate of 10° C. min⁻¹ by a liquid nitrogen cooling system, then equilibrated at −170° C. and held isothermally for another 20 min, finally followed by scanning from −170 to 25° C. at the rate of 5° C. min⁻¹. The freezing point of the electrolyte was acquired by taking the temperature at the onset of endothermic change from the thermal baseline (FIGS. 1a, 1b and Table 4).

TABLE 4

| | Experimental |
|---|---|
| Electrolyte no. | Freezing Points |
| C1 (commercial) | −30 |
| C2 (commercial) | −30 |
| C3 (commercial) | −50 |
| 2 mix | −71 |
| 4 mix | −111.84 |
| 6 mix | −124.36 |
| 8 mix-a | −124.34 |
| 8 mix-b | −126.66 |
| 10 mix | −130 |

The freezing points decreased greatly with an increase in the number of solvents from 2 mix to 10 mix. When the component number increased to 10, the freezing point of electrolyte significantly decreased to −130° C., far superior to ˜−30° C. of the commercial binary electrolytes C1 and C2. It was also further observed the decimal solvent-based electrolyte still existed as a liquid in an environmental chamber at −85° C., while commercial binary (C1, C2) and ternary solvent-based electrolytes (C3) were completely frozen at −60° C. (FIG. 1c).

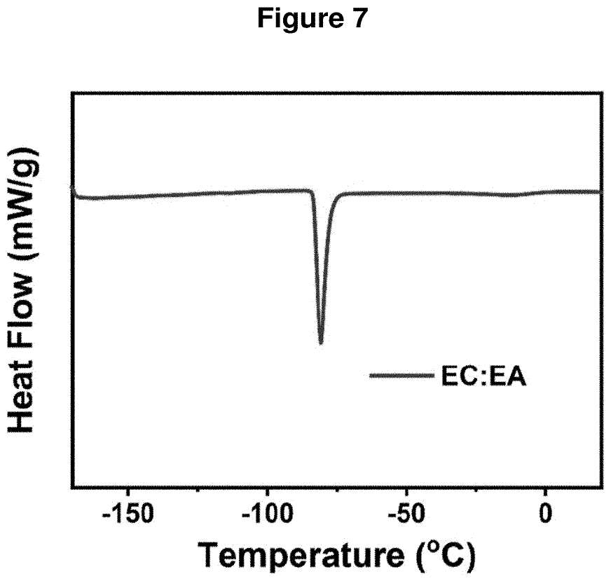

To show that the superior lowered freezing points of the electroytes of this invention was not due to the low content of EC, two mixtures, EC:EMC (1:9) and EC:EA (1:9, FIG. 7) were utilized as control samples and the DSC results showed no significant improvement in the freezing point of the electrolytes. Furthermore, the freezing crystallization of electrolytes commonly observed in commercial samples, was greatly suppressed with the introduction of more solvents, protecting LIBs from irreversible damage at extremely low temperatures (FIG. 1d).

### Example 3: Viscosity Measurements

The apparent viscosity of the electrolyte at various temperatures was obtained with a DV3T viscometer (Brookfield AMETEK, Middleboro, Mass., USA).

TABLE 5

| Electrolyte | Viscosity Measurements (cP, ° C.) | | | | |
|---|---|---|---|---|---|
| no. | 25 | 20 | 15 | 10 | 5 |
| C2 (commercial) | 4.7 | 5.2 | 6.0 | 7.1 | 8.6 |
| C3 (commercial) | 4.1 | 4.7 | 5.5 | 6.9 | 8.0 |
| 4 mix | 3.8 | 4.3 | 4.9 | 5.8 | 6.5 |
| 6 mix | 3.1 | 3.4 | 4.0 | 4.7 | 5.5 |
| 8 mix-a | 3.1 | 3.4 | 3.8 | 4.4 | 5.0 |
| 8 mix-b | 2.9 | 3.3 | 3.8 | 4.4 | 5.1 |
| 10 mix | 3.0 | 3.4 | 3.9 | 4.4 | 5.2 |

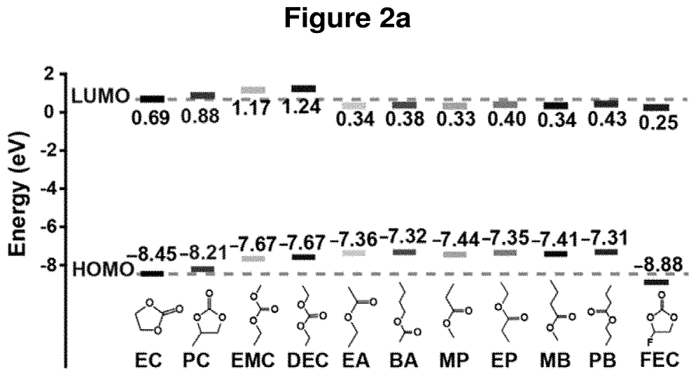

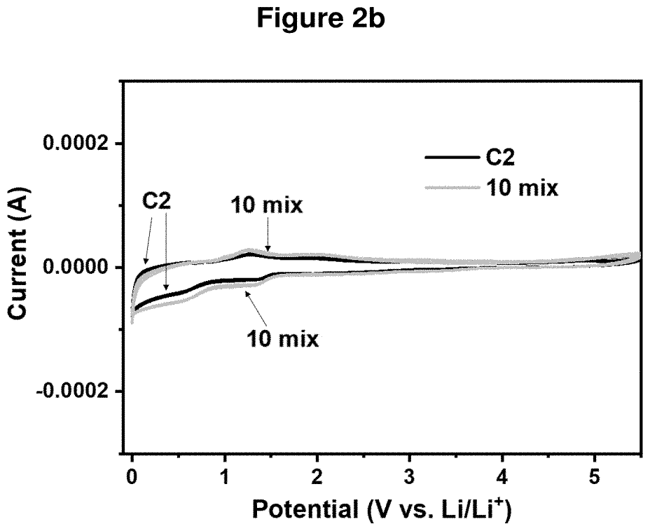

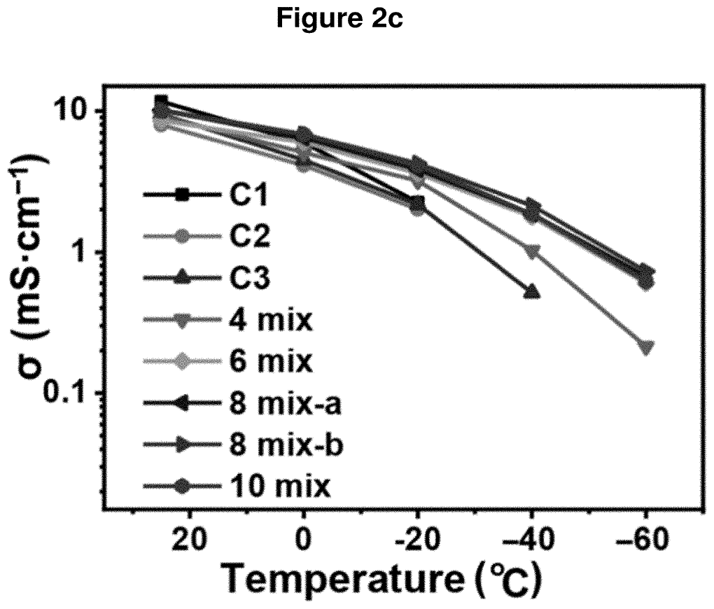

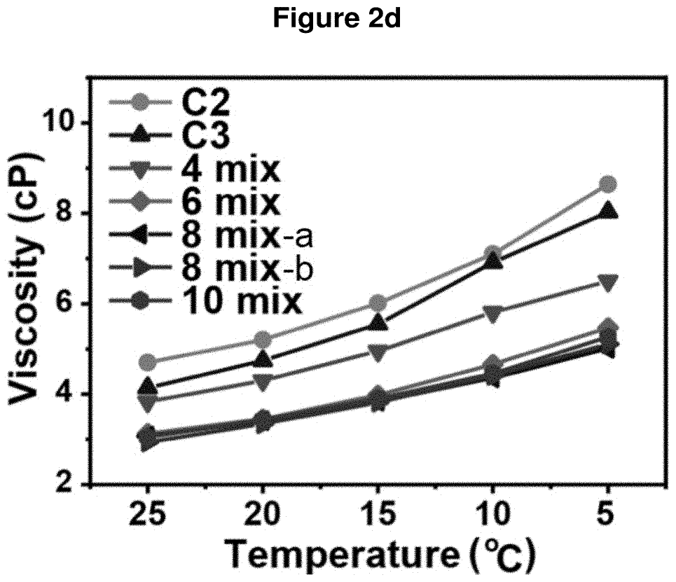

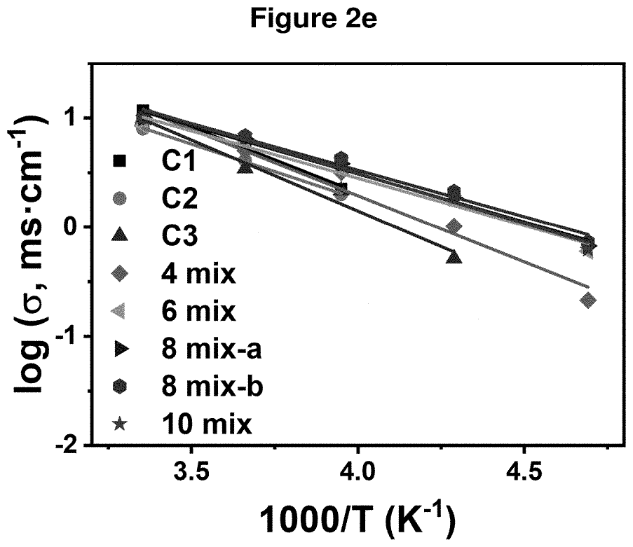

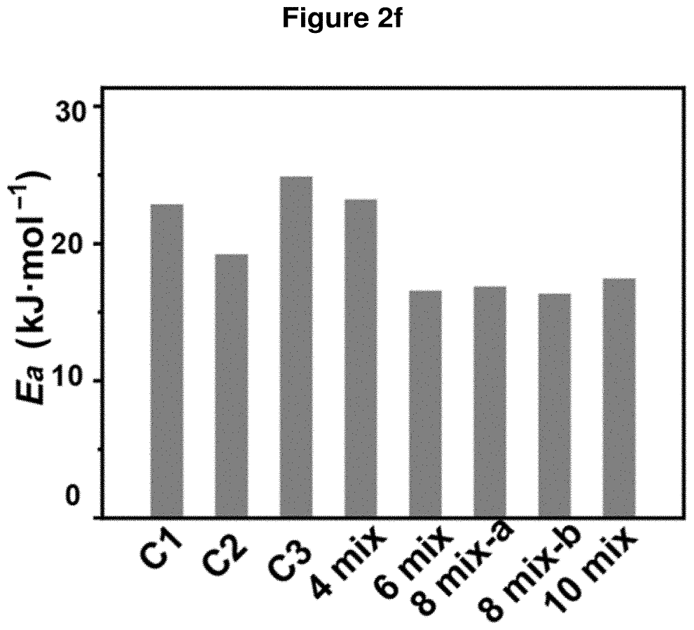

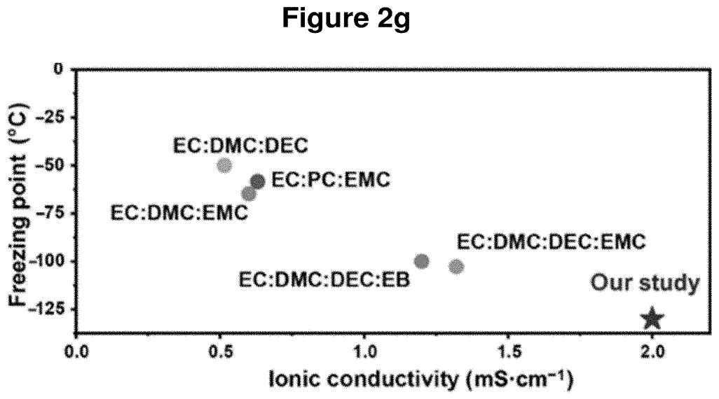

Viscosity measurements showed both the commercial electrolytes (C2, C3) have higher viscosities compared to the electrolytes of this current invention. Additionally, viscosities of the commercial electrolytes increased at a higher rate compared to the decimal solvent-based electrolytes when temperature was reduced 25° C. to 5° C. (FIG. 2d and Table 5)

### Example 4: Ionic Conductivity Measurements

The ionic conductivity of electrolytes at various temperatures was measured with electrochemical impedance spectroscopy (EIS) (Solartron, Farnborough, Hampshire, UK).

The ionic conductivity of commercial and multicomponent electrolytes was studied over a range of temperatures. At room temperature (25° C.), these electrolytes showed comparable Li⁺ diffusivity (FIG. 2c and Table 6).

TABLE 6

| Electrolyte | Ionic Conductivity Measurement (mS · cm⁻¹, ° C.) | | | | |
|---|---|---|---|---|---|
| no. | 25 | 0 | −20 | −40 | −60 |
| C2 (commercial) | 8 | 4 | 2 | 0.7 | 0.02 |
| C3 (commercial) | 9 | 3 | 2 | 0.5 | 0.02 |
| 4 mix | 9 | 5 | 2.5 | 0.9 | 0.15 |
| 6 mix | 8.5 | 4.6 | 2.3 | 0.8 | 0.15 |
| 8 mix-a | 10 | 6 | 4 | 2 | 0.6 |
| 8 mix-b | 10 | 7 | 4 | 2 | 0.7 |
| 10 mix | 10 | 7 | 4 | 2 | 0.62 |

The ionic conductivity of commercial binary and ternary solvent-based electrolytes were observed to decrease significantly with decreasing temperature, especially below −40° C. In comparison, the electrolytes of this present invention displayed better ionic conductivities relative to the commercial electrolytes at the same temperature. In particular, the 10 mix electrolyte exhibited an unprecedented high conductivity of 0.62 mS·cm−1 at −60° C., several orders of magnitude greater than the commercial C2 electrolyte. Such high ionic conductivity might be attributed to the comparatively lower viscosity of electrolyte of this present invention.

TABLE 7

| | Activation Energy |
|---|---|
| Electrolyte no. | (kJ · mol⁻¹) |
| C2 (commercial) | 22 |
| C3 (commercial) | 25 |
| 4 mix | 25 |
| 6 mix | 25 |
| 8 mix-a | 17 |
| 8 mix-b | 16 |
| 10 mix | 17 |

The lower ionic conductivities may also be explained using the activation energy for Li⁺ diffusion. The activation energy of Li⁺ diffusion in electrolytes, obtained from the slope of the σ versus 1/T plot (FIG. 2e), was significantly reduced by about 30% when the solvent number increased to six (FIG. 2f and Table 7).

In terms of both liquidus temperature and lithium diffusion capability at −40° C., the electrolytes of the present invention are much superior to the commercial electrolytes (FIG. 2g). Therefore, the introduction of decimal solvents endows electrolytes with both an ultra-low freezing point and high low-temperature ionic conductivity.

### Example 5: Exemplary Entropy Measurement

The heat production of solvent mixing was monitored by Nano isothermal titration calorimetry (Nano ITC) (TA Instruments). PC-to-EA titration was conducted at 25° C. with per injection volume of 2 μL and the titration interval of 300 s. The molar density of PC and EA is 0.010588 and 0.009214 mol·mL⁻¹, respectively.

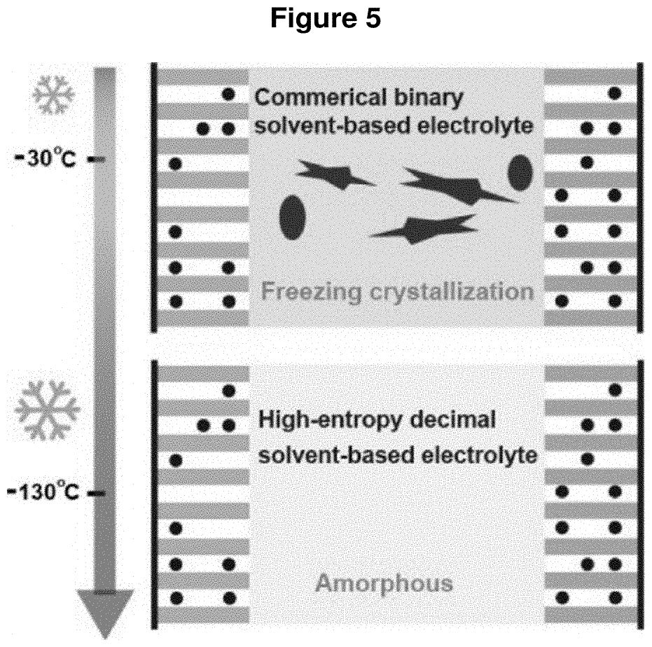

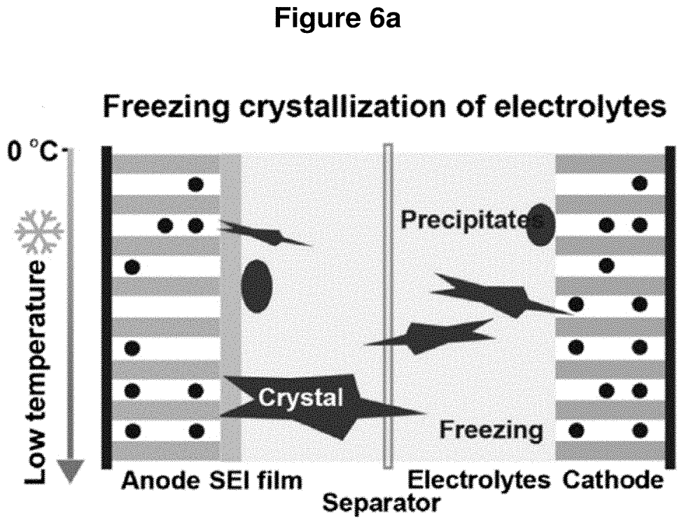

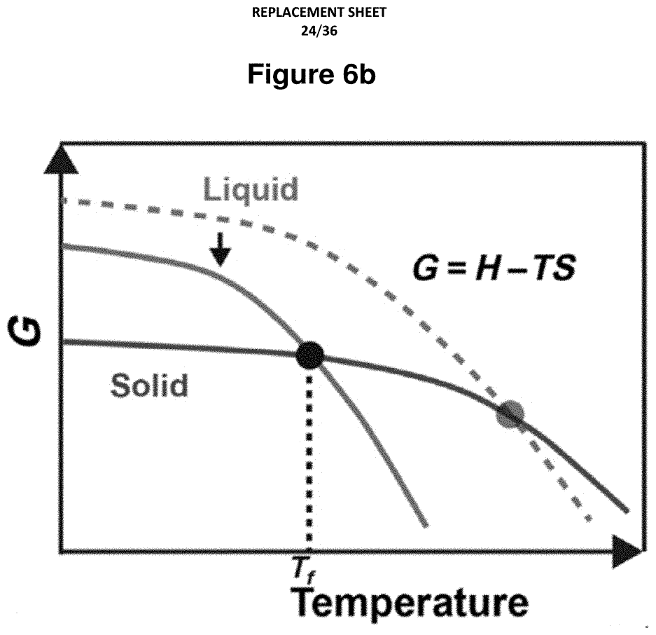

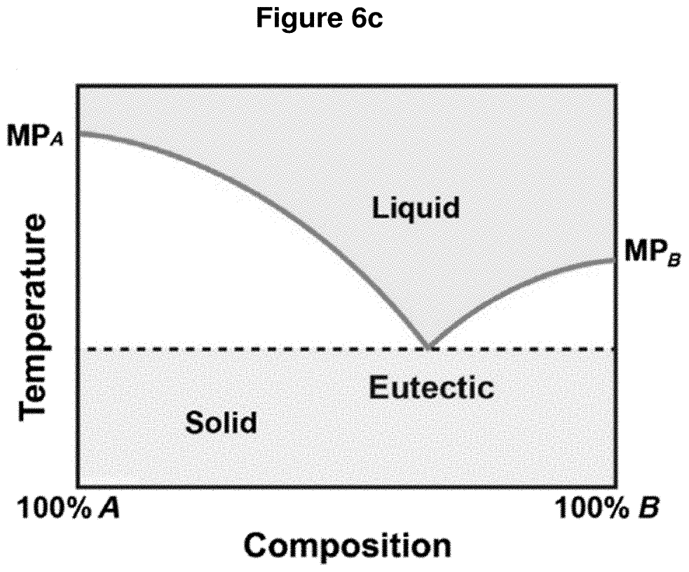

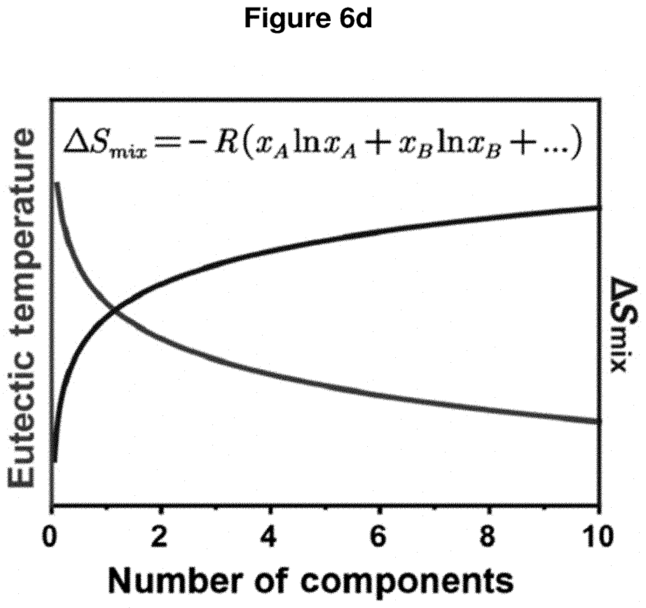

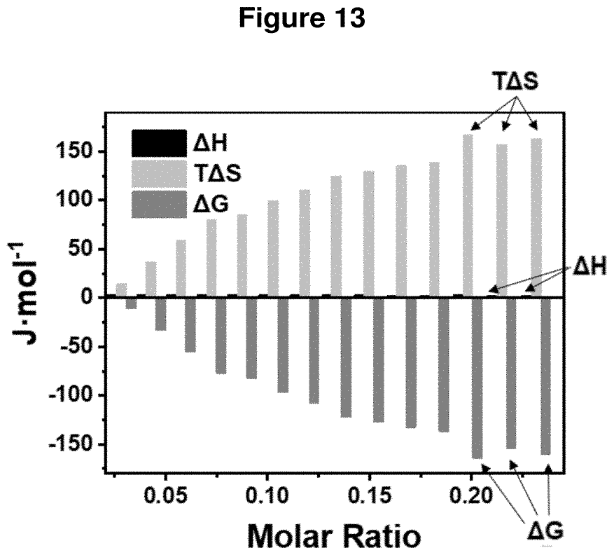

The underlying mechanism behind the freezing point depression was investigated by ITC (TA Instruments, New Castle, Del., USA), taking the mixing of PC and EA as an example. The heat production during mixing includes two contributions: the change of enthalpy and entropy. The enthalpy contribution was calculated from the measured heat of ideal mixing in the stirring mode from Redlich-Kister polynomial equations (FIG. 4a), while the entropy change could be computed (FIG. 4c) based on the deviations of heat production (FIG. 4b) in the non-stirring mode from ideal mixing. These results demonstrated that the introduction of more kinds of miscible solvents increased the system entropy (FIG. 13), which is the underlying reason for the greatly depressed freezing point of multicomponent electrolytes (FIG. 6d). Based on these observations, a comprehensive picture of the whole process can be obtained (FIG. 4d). For commercial binary solvent-based electrolytes, the system is more ordered. The higher melting point component of EC is more inclined to precipitate first with the decrease of temperature, followed by lithium salt and other solvents, in the form of orderly crystals. This freezing crystallization may cause irreversible mechanical damage to the separator and SEI film of LIBs. The molecular ordering also limits the lowering of the liquidus temperature of commercial electrolytes (˜−30° C.). For decimal solvent-based high-entropy electrolytes, the mixture is more disordered. EC molecules are more separated from each other. Therefore, the transition temperature at which electrolytes turn from liquid into solid can be lowered to −10° C. Meanwhile, freezing of this decimal solvent-based electrolyte favors the formation of amorphous solid, which is less damaging to LIB internal structures (FIGS. 5, 6a). As a result, the lowered freezing point and suppressed crystallization of decimal solvent-based high-entropy electrolyte extend the survival temperature range of LIBs significantly.

### Example 5: Electrode Fabrication

LMO and LTO were used as active materials of the cathode and anode respectively. Binder and conductive agents were used without further treatment. For the preparation of working electrodes, active materials (80 wt %) and conductive agent (10 wt %) were thoroughly mixed with binders (10 wt %). The homogenous slurry was pasted on aluminum or copper foil and dried in air at 60° C. for 2 h, and then dried in vacuum at 100° C. overnight to remove residual solvent.

### Example 6: Electrolyte Testing

Electrochemical properties were investigated using CR2032 coin-type cells. All cells were assembled inside an argon-filled glovebox with oxygen and water contents below 0.6 ppm. Commercial electrolytes and our designed electrolytes with the varied number of solvents were used as the battery electrolyte. The discharging/charging tests of batteries were performed on a NEWARE battery analyzer (Shenzhen, Guangdong, China) at different current rates. For the measurement of low-temperature performance, the batteries were placed in a climatic chamber (ESPEC, Kita-ku, Osaka, Japan) and rested to reach thermal equilibrium. Linear sweep voltammetry was carried out on an electrochemical station (Solartron).

Using a LMO/LTO full cell as a model system, these electrolytes of the present invention were used to test LIBs operating at low temperatures.

TABLE 8

| | C2 | 10 mix |
|---|---|---|
| Temperature | Specific capacity | Specific capacity |
| (° C.) | (mAh⁻¹g⁻¹) | (mAh⁻¹g⁻¹) |
| 25 | 110 | 110 |
| 0 | 105 | 109 |
| −20 | 90 | 109 |
| −40 | 0 | 98 |
| −60 | 0 | 43 |

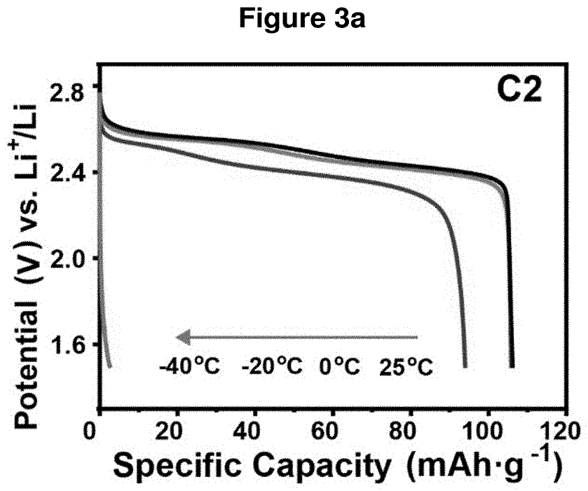

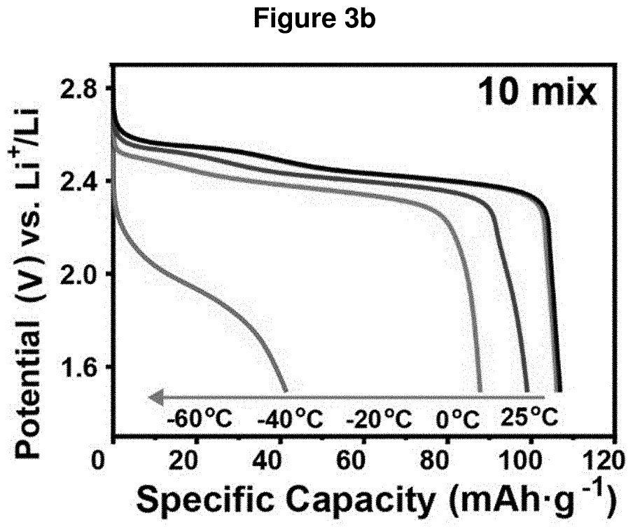

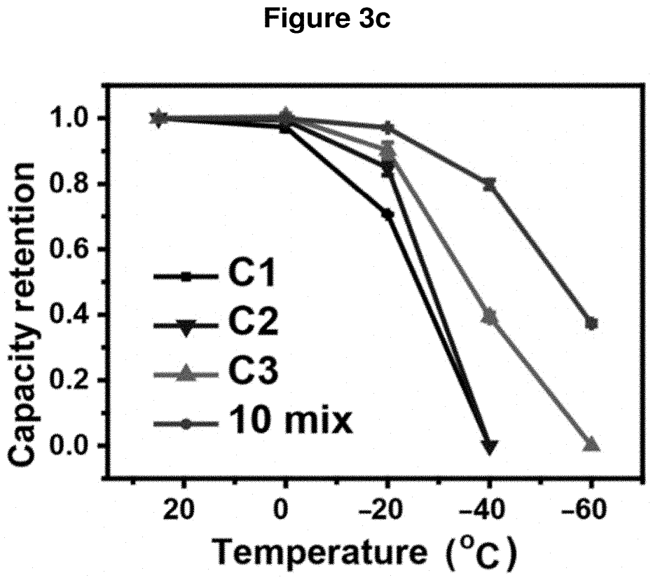

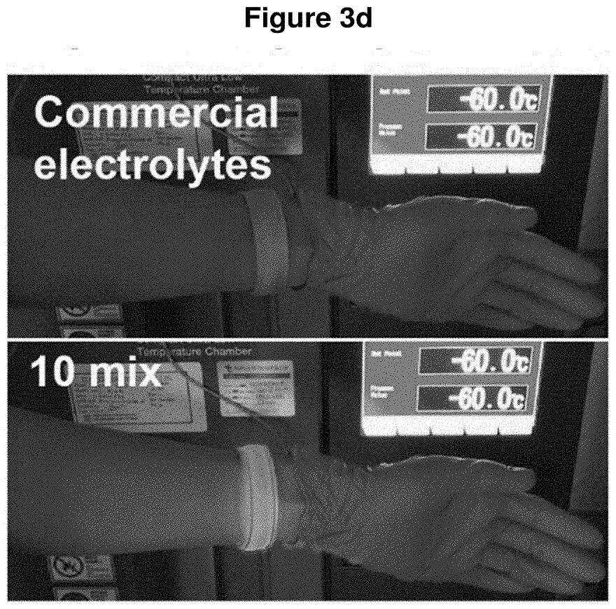

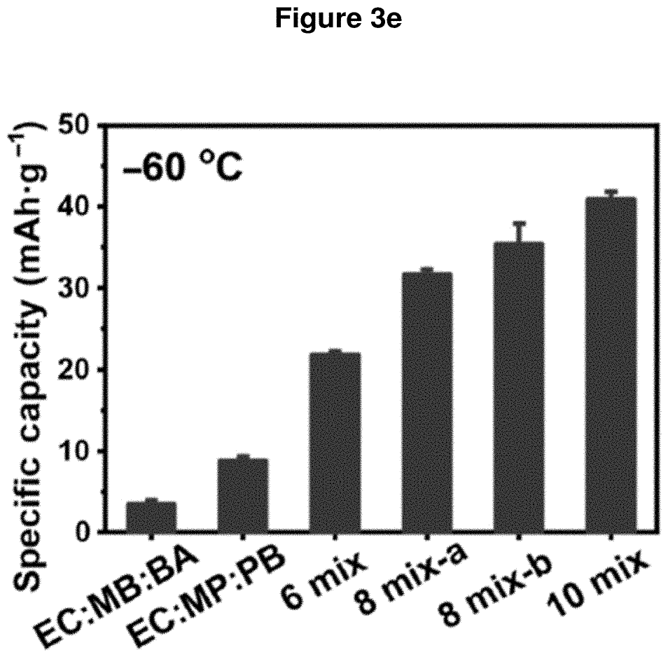

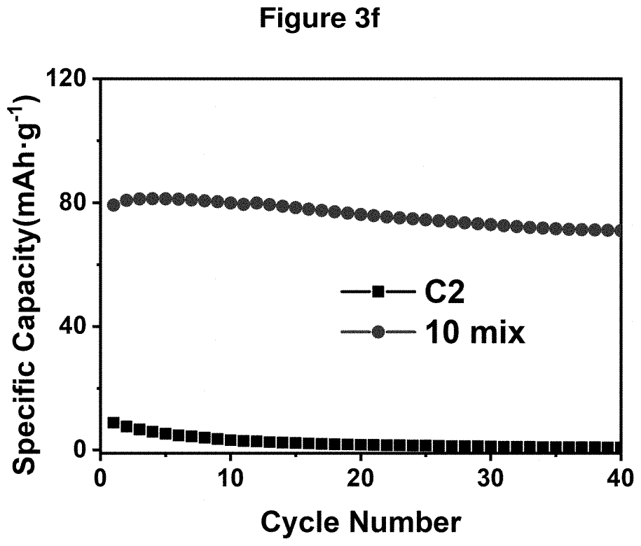

For batteries with commercial binary and ternary solvent-based electrolytes, both capacity and discharging voltage greatly decreased with the temperature, and the battery can hardly be discharged below −40° C. (FIG. 3a and Table 8). In comparison, the 10 mix electrolyte of the present disclosure could be discharged even well below −60° C. (FIG. 3b).

TABLE 9

| | Specific Capacity retention (mAh−1g−1) | | | | | | |
|---|---|---|---|---|---|---|---|
| Temperature | | | | | 8 mix | 8 mix | |
| (° C.) | C1 | C2 | C3 | 6 mix | a | b | 10 mix |
| 25 | 110 | 110 | 110 | 110 | 110 | 110 | 110 |
| 0 | 105 | 105 | 106 | 108 | 108 | 108 | 109 |
| −20 | 81 | 90 | 94 | 108 | 108 | 108 | 109 |
| −40 | 0 | 0 | 0 | 52 | 73 | 78 | 98 |
| −60 | 0 | 0 | 0 | 21 | 32 | 36 | 43 |

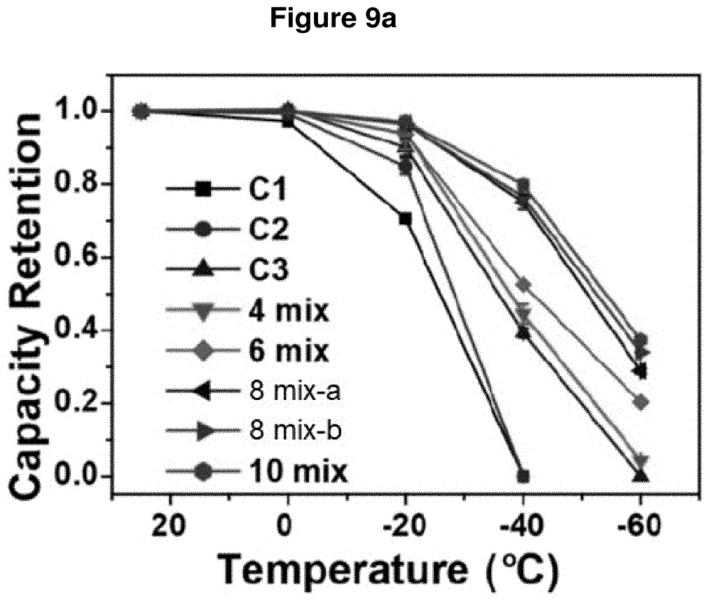

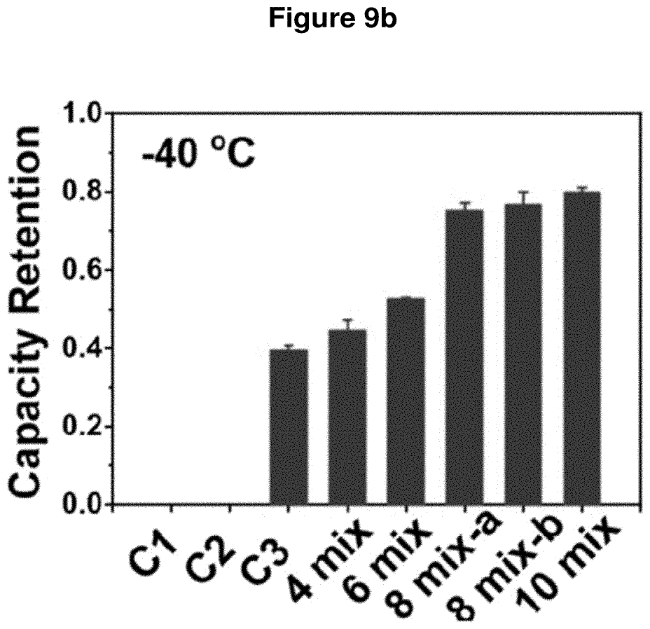

For high-entropy decimal solvent-based electrolyte, the capacity retention at low temperatures is significantly enhanced and the battery can maintain 80% capacity at −40° C. and about 37% at −60° C. at 0.1 C (1 C=140 m·g⁻¹) (FIGS. 3c, 3e, 9a and 9b and Table 9). Notably, our batteries are charged and discharged at the same low temperatures instead of the conventional testing routine, wherein the LIBs are charged at a higher temperature followed by test-charging at a lower temperature.

TABLE 10

| | |
|---|---|
| | Specific Capacity Retention |
| Rate of Charging | (mAh⁻¹g⁻¹) |

| (C) | C3 | 10 mix |
|---|---|---|
| 0.2 | 32 | 81 |
| 0.5 | 18 | 78 |
| 1 | 8.6 | 68 |
| 2 | 0 | 41 |

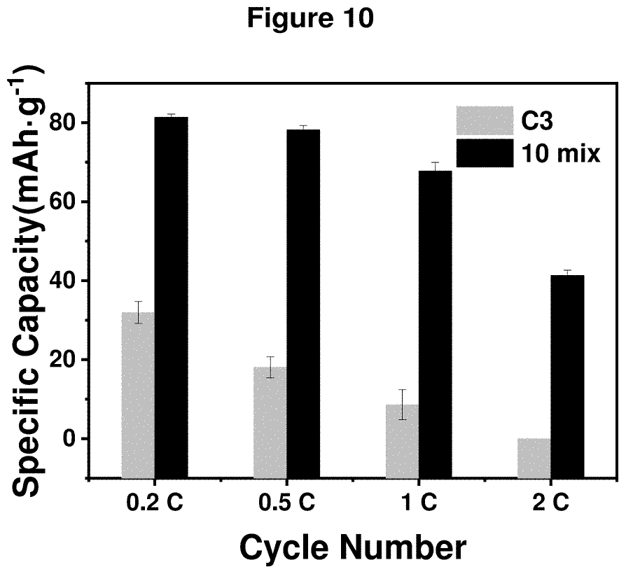

Meanwhile, the batteries with decimal solvent-based electrolyte displayed significantly enhanced rate performance at sub-zero temperatures (FIG. 10 and Table 10) compared to batteries containing commercial C3 electrolytes.

### Example 7: Testing Electrolyte in Other Cathodes

TABLE 11

| | Specific Capacity Retention in | | Specific Capacity Retention in | |
|---|---|---|---|---|
| Temperature | LCO/LTO cell (mAh⁻¹g⁻¹) | | NMC111/LTO cell (mAh⁻¹g⁻¹) | |
| (° C.) | C2 | 10 mix | C2 | 10 mix |
| −40 | 0 | 89.5 | 0 | 81.8 |
| −50 | 0 | 6.7 | 0 | 49.7 |

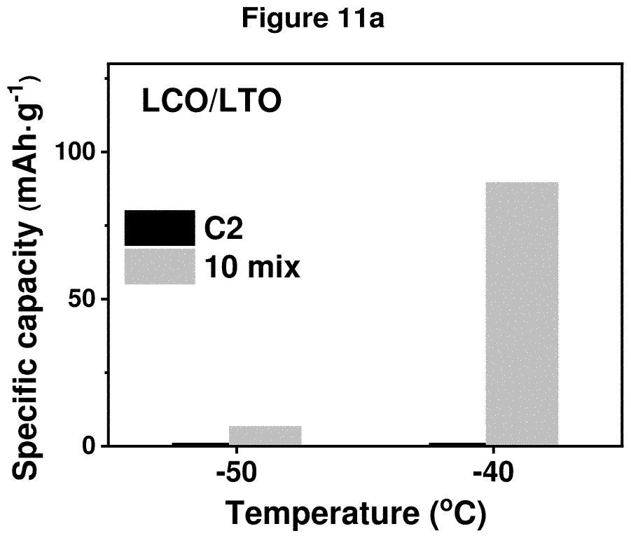

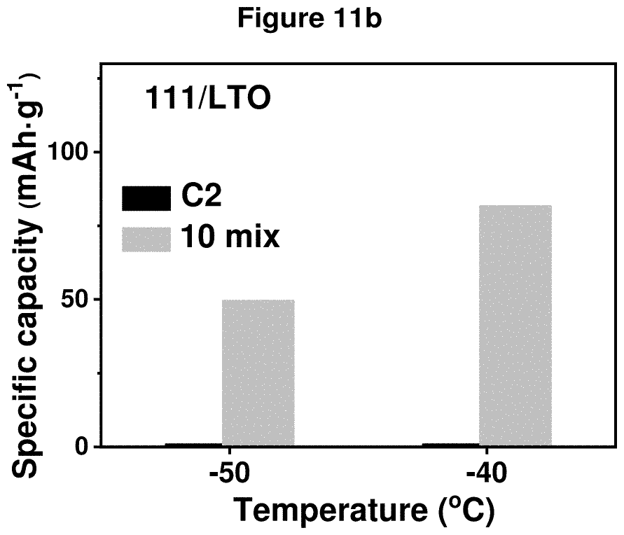

The same decimal solvent-based electrolytes were similarly applied to cells containing other types of electrodes (FIGS. 11a, 11 b and Table 11). Lithium Cobalt Oxide (LCO) and NMC111 as cathodes were tested and results showed that batteries were able to discharge at similar efficiencies relative to cells using LMO as cathode. It was additionally found that LCO and NMC111 batteries containing decimal solvent-based electrolytes had better capacity retention compared to batteries containing C2 as an electrolyte. This demonstrated the versatility of the decimal solvent-based electrolyte in other electrochemical cell applications.

### Example 8: Cycling Performance

The cycling performance of the electrolyte was additionally tested on an LMO/LTO cell, using a C2 electrolyte as a control.

TABLE 12

| | |
|---|---|
| | Specific Capacity Retention at −40° C. |
| Cycle | (mAh⁻¹g⁻¹) |

| Number | C2 | 10 mix |
|---|---|---|
| 10 | 3.2 | 79.9 |
| 20 | 1.7 | 76.2 |
| 30 | 1.1 | 72.9 |
| 40 | 0.82 | 71 |

TABLE 13

| | 10 mix | |
|---|---|---|
| Cycle | Coulombic Efficiency | Specific Capacity Retention at 25° C. |
| Number | (%) | (mAh⁻¹g⁻¹) |
| 50 | 99.675 | 52.96793 |
| 100 | 99.676 | 50.65465 |
| 150 | 99.678 | 48.52192 |
| 200 | 99.68 | 46.49876 |

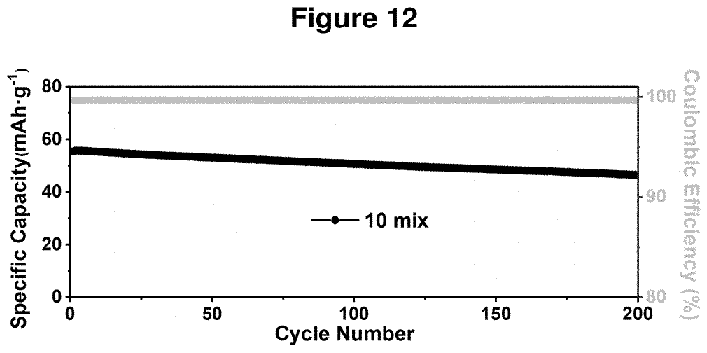

The cycling performance of the electrolyte was measured at 25° C. using an LMO/LTO cell. Results showed that the specific capacity retention of the cell decreased by only 12.2% after 200 charging/discharging cycles, showing the robustness of the electrolyte (FIG. 12 and Table 13). The cycling performance of the cell containing the electrolyte was also tested at low temperatures, using the C2 electrolyte as a control. We were able to demonstrate the superior performance of decimal solvent-based electrolytes over a commercial binary solvent-based electrolyte at −40° C. (FIG. 3f and Table 12). The decimal solvent-based electrolyte was able to maintain its original specific capacity retention after 40 cycles, but the commercial electrolyte had much poorer discharge values.

### Example 9: Practical Application

The practical applications of the cell containing the decimal solvent-based electrolyte was additionally tested. The batteries containing the decimal solvent-based electrolyte and commercial electrolyte (C1) were initially stored at −85° C., after which they were equilibrated to −60° C. and tested on a wristband. Even after storage at ultra-low temperatures, the battery with decimal solvent-based electrolyte still works well and was able to light up a wristband at −60° C. (FIG. 3d).

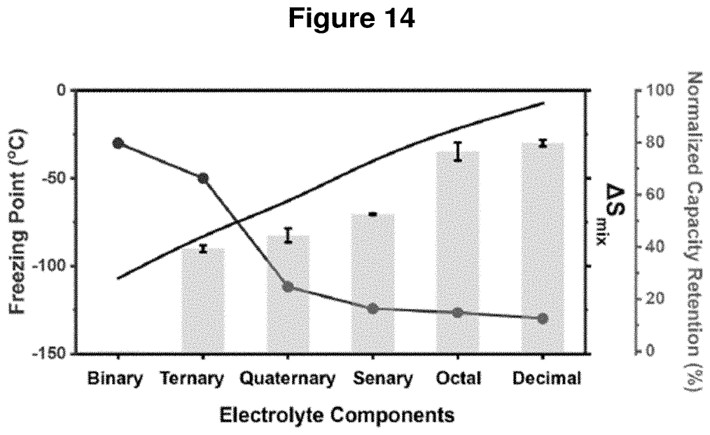

This should be attributed to the unprecedented low freezing point of −130° C. and the suppressed freezing crystallization of the high-entropy electrolyte, according to the experiments above (FIG. 14). Other concerns like the Jahn-Teller distortion of the LMO cathode and gassing of the LTO anode may be further addressed via doping and coating, as well as additional electrolyte formulation for practical applications. However, the decimal solvent-based electrolytes of this present invention well extend the survival and operation temperature range for LIBs.

### INDUSTRIAL APPLICABILITY

The present invention relates to high-entropy electrolytes for use in electrochemical cell applications, particularly low-temperature applications. The electrolytes of the present invention possess unprecedented freezing points compared to the currently known electrolytes. The electrolytes of the present invention also do not undergo freezing crystallisation, which reduces damage to the electrochemical cells, increasing longevity and capacity of the cells, while reducing maintenance and production costs. Thus, this invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. An electrolyte for an electrochemical cell comprising:
Solvent A selected from cyclic carbonate; and
Solvent Group B comprising at least four organic solvents, each organic solvent having a Highest Occupied Molecular Orbital (HOMO) level between about −9 eV to about −7 eV, and an energy band gap of at least about 5 eV between the HOMO and Lowest Unoccupied Molecular Orbital (LUMO).

2. The electrolyte of claim 1, wherein Solvent Group B comprises four, five, six, seven, eight, or nine organic solvents.

3. The electrolyte of claim 1, wherein the LUMO level of the organic solvents in Solvent Group B is between about 0 eV to about 1.5 eV.

4. The electrolyte of claim 1, wherein Solvent A is selected from the group consisting of ethylene carbonate, propylene carbonate, vinylene carbonate, and vinylethylene carbonate.

5. The electrolyte of claim 1, wherein the electrolyte comprises about 5 vol % to about 20 vol % Solvent A.

6. The electrolyte of claim 1, wherein Solvent Group B comprises organic solvents selected from the group consisting of cyclic or linear carbonates, halogenated cyclic or linear carbonates, cyclic or linear acid esters, halogenated cyclic or linear acid esters, cyclic or linear acid amides, halogenated cyclic or linear acid amides, cyclic or linear ethers, halogenated cyclic or linear ethers, cyclic or linear esters, halogenated cyclic or linear esters, cyclic or linear carbamates, halogenated cyclic or linear carbamates, and nitriles.

7. The electrolyte of claim 1, wherein Solvent Group B comprises cyclic carbonates, linear carbonates, and linear esters.

8. The electrolyte of claim 1, wherein Solvent Group B comprises propylene carbonate, dimethyl carbonate, ethyl methyl carbonate, diethyl carbonate, ethyl acetate, butyl acetate, methyl propionate, ethyl propionate, methyl butyrate, or propyl butyrate.

9. The electrolyte of claim 1, wherein the organic solvents in Solvent Group B are in equivolume ratio to each other.

10. The electrolyte of claim 1, wherein Solvent A and the organic solvents in Solvent Group B are in equivolume ratio to each other.

11. The electrolyte of claim 1, comprising
ethylene carbonate;
propylene carbonate; and
at least three organic solvents selected from the group consisting of ethyl methyl carbonate, diethyl carbonate, ethyl acetate, butyl acetate, methyl propionate, ethyl propionate, methyl butyrate, or propyl butyrate.

12. The electrolyte of claim 11, comprising at least about 20 vol % ethylene carbonate and propylene carbonate.

13. The electrolyte of claim 1, further comprising one or more additives selected from the group consisting of halogenated cyclic carbonate, non-halogenated cyclic carbonate, halogenated linear carbonate, non-halogenated linear carbonate, vinylene carbonate, fluoroethylene carbonate, and lithium salt.

14. The electrolyte of claim 1, wherein the electrolyte further comprises about 0.5 vol % to about 5 vol % halogenated cyclic carbonate, non-halogenated cyclic carbonate, halogenated linear carbonate, non-halogenated linear carbonate, unsaturated cyclic carbonate, unsaturated linear carbonate, and/or fluoroethylene carbonate.

15. The electrolyte of claim 1, wherein the electrolyte comprises about 0.5 M to about 3 M lithium salt.

16. The electrolyte of claim 1, wherein the lithium salt is selected from the group consisting of lithium hexafluorophosphate, lithium bis(oxalate)borate, lithium difluorooxolato borate, lithium hexafluoroarsenate (V), lithium hexafluorophosphate, lithium bis(trifluoromethanesulfonyl)imide, lithium bis(perfluoroethanesulfonyl)imide, lithium tetrafluoroborate, lithium perchlorate, lithium trifluoromethanesulfonate, lithium tris(trifluoromethanesulfonyl)methide, lithium bis(oxalato)borate or any combinations or mixtures thereof.

17. The electrolyte of claim 1, wherein Solvent A and Solvent Group B of the electrolyte comprise:
ethylene carbonate, propylene carbonate, diethyl carbonate, ethyl methyl carbonate, ethyl propionate, and ethyl acetate;
ethylene carbonate, propylene carbonate, diethyl carbonate, ethyl methyl carbonate, ethyl propionate, ethyl acetate, methyl butyrate, and butyl acetate;
ethylene carbonate, propylene carbonate, diethyl carbonate, ethyl methyl carbonate, ethyl propionate, ethyl acetate, methyl butyrate, and propyl butyrate; or
ethylene carbonate, propylene carbonate, diethyl carbonate, ethyl methyl carbonate, ethyl propionate, ethyl acetate, methyl butyrate, butyl acetate, methyl propionate, and propyl butyrate.

18. The electrolyte of claim 1, wherein the electrolyte comprises:
ethylene carbonate, propylene carbonate, diethyl carbonate, ethyl methyl carbonate, ethyl propionate, ethyl acetate, about 0.5 vol % to about 5 vol % fluoroethylene carbonate, and about 0.5 M to about 3 M LiPF₆;
ethylene carbonate, propylene carbonate, diethyl carbonate, ethyl methyl carbonate, ethyl propionate, ethyl acetate, methyl butyrate, butyl acetate, about 0.5 vol % to about 5 vol % fluoroethylene carbonate, and about 0.5 M to about 3 M LiPF₆;
ethylene carbonate, propylene carbonate, diethyl carbonate, ethyl methyl carbonate, ethyl propionate, ethyl acetate, methyl butyrate, propyl butyrate, about 0.5 vol % to about 5 vol % fluoroethylene carbonate, and about 0.5 M to about 3 M LiPF₆; and
ethylene carbonate, propylene carbonate, diethyl carbonate, ethyl methyl carbonate, ethyl propionate, ethyl acetate, methyl butyrate, butyl acetate, methyl propionate, propyl butyrate, about 0.5 vol % to about 5 vol % fluoroethylene carbonate, and about 0.5 M to about 3 M LiPF₆.

19. The electrolyte of claim 1, wherein the electrolyte has a freezing point in the range of about −100° C. and lower.

20. An electrochemical cell comprising the electrolyte of claim 1.
